(19) United States
(12) Patent Application Publication
(10) Pub. No.: US 2002/0124000 A1
(43) Pub. Date: Sep. 5, 2002

(54) Schedule adjustment method, method and apparatus for schedule management, capable of automatically adjusting schedule

(75) Inventor: Tsukasa Ooishi, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/948,566

(22) Filed: Sep. 10, 2001

(30) Foreign Application Priority Data
Mar. 2, 2001 (JP) 2001-058332(P)

(51) Int. Cl. G06F 7/00

(52) U.S. Cl. 707/10

(57) ABSTRACT

A comparison loop counter compares a schedule whose adjustment is requested from a user with a schedule as an object for adjustment stored in a data base. When the schedule whose adjustment is requested does not coincide with an unassigned time zone of the schedule as an object for adjustment, position shift circuit change the schedule whose adjustment is requested in a range of a flexibility time zone set to the schedule and the comparison loop counter adjusts such that the schedule whose adjustment is requested coincides with an unassigned time zone of the schedule as an object for adjustment. As a result, when a request for schedule registration from a user occurs, the schedule can be automatically adjusted taking into consideration schedules of other users.

### BACKGROUND OF THE INVENTION

1. Field of the Invention

The present invention relates to a schedule adjustment method, a method and apparatus for schedule management, mutually adjusting and managing plural schedules of respective plural clients.

2. Description of the Background Art

In recent years, a schedule management function has been incorporated in an information processing apparatus such as an electronic notepad, a word processor and a personal computer, and schedule management for individuals with this function have become popular.

As a schedule management apparatus managing such an individual's schedule, a schedule management apparatus is disclosed in Japanese Patent Laying-Open No. 8-006995 in which schedules of plural persons are registered in plural modes. A unconditional registration mode, an ordinary mode and an approval mode are provided in this schedule management apparatus described in Japanese Patent Laying-Open No. 8-006995.

The unconditional registration mode is a mode in which a schedule whose registration is requested by a user is registered without searching whether or not the schedule of the request overlaps a schedule already registered of another user.

The ordinary mode is a mode in which a schedule whose registration is requested by a user is registered in a limited case where an unassigned time is available being not overlapped by a schedule already registered of another user.

The approval mode is a mode in which a schedule whose registration is requested by a user is registered in a case where registration of the schedule of the request is approved by another user.

Furthermore, in the schedule management apparatus described in Japanese Patent Laying-Open No. 8-006995, a mode suited for the purpose of usage is selected among the plural modes and schedules of individuals are registered. For example, in a case where one schedule management apparatus plays a role of a schedule board storing schedules of all members, a processing mode of the schedule management apparatus is set to the unconditional registration mode. In the case, users each not only input an individual schedule to a schedule management apparatus dedicated solely to a specific user, but also transmit a request for registration of the individual schedule to a schedule management apparatus managing a schedule board to write the individual schedule on the schedule board. The schedule management apparatus managing the schedule board unconditionally registers and stores all requests for registration of schedules; therefore, the schedules of members are all stored regardless of whether or not each of the schedules overlap another.

In a case where one schedule management apparatus has a function managing a reservation securing usage of equipment and facilities such as the reservation of a conference room, the ordinary mode is set. The ordinary mode is to receive only one request earliest in time for schedule reservation among requests of the same kind and realize a reservation system on the first come, first served basis.

In addition, in a case where a schedule management apparatus is used in other applications, a processing mode is set according to a user's preference. If a user does not want that a schedule requested by a second user is registered at the second user's disposal, the approval mode is only required to be set.

The schedule management apparatus described in Japanese Patent Laying-Open No. 8-006995, as described above, is operated such as to change a registration method for an individual's schedule according to the purpose of usage.

Moreover, described in Japanese Patent Laying-Open No. 9-027000 is a schedule management system in which a request for schedule registration from an user is transmitted to a second user and schedule adjustment between users is effected by a response of the second user to the schedule requested by the first user.

In the schedule management apparatus described in Japanese Patent Laying-Open No. 8-006995 and a schedule management system described in Japanese Patent Laying-Open No. 9-027000, however, a problem has arisen that when a request for schedule adjustment from a first user occurs, the schedule of the request from the first user cannot be automatically adjusted so as not to overlap a schedule of a second user. That is, in the schedule management system described in Japanese Patent Laying-Open No. 9-027000, a schedule management apparatus performs only operations of transmitting a received schedule to a second user or transmitting a response from the second user to a first user requesting adjustment but does not adjust schedules of plural users automatically.

Moreover, since the schedule management apparatuses described in the above described two publications each register schedules of users or are used for adjustment between the schedules, there has arisen a problem that the users each cannot manage the schedules so as to perform a next schedule.

In addition, in a schedule management apparatus managing a schedule for a production line in which products have to be delivered before and on the due date, the products cannot be sold if the schedule for a production line of the products is set so that the products are actually produced at a date later than the due date.

### SUMMARY OF THE INVENTION

It is accordingly an object of the present invention to provide a schedule adjustment method and a schedule management apparatus automatically adjusting a schedule of a user taking into consideration a schedule of a second user in a case where a request for schedule registration is made by the user.

It is another object of the present invention to provide a schedule management method managing schedules of users such that the schedules are correctly performed.

It is still another object of the present invention to provide a schedule management method managing schedules in plural production lines such that products can be produced by a delivery date.

According to the present invention, a schedule adjustment method is a schedule adjustment method adjusting plural schedules, in each of which a registration time zone and a first flexibility time zone showing a range in which the registration time zone can be changed are set, including: a first step of extracting plural schedules each as an object for adjustment from the plural schedules in response to a request for schedule adjustment; a second step of receiving a schedule whose adjustment is requested and which is composed of a desired time zone and a second flexibility time zone showing a range in which the desired time zone can be changed; a third step of comparing the schedule whose adjustment is requested with the plural schedules each as an object for adjustment to adjust such that the schedule whose adjustment is requested coincides with plural schedule setting enabling time zones of the plural schedules each as an object for adjustment; a fourth step of updating the plural schedules each as an object for adjustment when the schedule whose adjustment is requested coincides with the plural schedule setting enabling time zones; and a fifth step of originating a result of the adjustment in the third step, wherein a schedule setting enabling time zone is a time zone obtained by summing an unassigned time zone and the first flexibility time zone.

It is preferable that in the third step, the schedule whose adjustment is requested is adjusted so as to coincide with plural unassigned time zones by changing the desired time zone in a range of the second flexibility time zone when the desired time zone does not coincide with the plural unassigned time zones.

It is preferable that in the third step, the schedule whose adjustment is requested is adjusted so as to coincide with plural unassigned time zones by further changing the plural unassigned time zones in ranges of respective corresponding first flexibility time zones when the schedule whose adjustment is requested does not coincide with the plural unassigned time zones even if the desired time zone is changed in a range of the second flexibility time zone.

It is preferable that in the third step, a common time zone in which a schedule in common with the plural schedules each as an object for adjustment can be set is further detected when the schedule whose adjustment is requested does not coincide with plural unassigned time zones even if the plural unassigned time zones are changed in ranges of the respective corresponding first flexibility time zones.

Furthermore, according to the present invention, a schedule management method is a schedule management method managing plural schedules in each of which a registration time zone and a flexibility time zone showing a range in which the registration time zone can be changed are set, including: a first step of extracting plural schedules each as an object for management having the same schedule from the plural schedules in response to a request for schedule management; a second step of detecting a residual time till a next scheduled time point from a current time point on the basis of the plural schedules each as an object for management; and a third step of transmitting the residual time detected in the second step to a client.

It is preferable that the schedule management method further includes a fourth step of originating a notification signal to urge a client to move to a destination at a next scheduled time point when the residual time is compared with a prescribed value and the residual time coincides with the prescribed value.

It is preferable that in the fourth step, a travel time of the client, who has transmitted a request for schedule management, from a current position to a destination included in the plural schedules each as an object for management is further detected to originate a notification signal on the basis of a difference in time obtained by subtracting the travel time from the residual time.

It is preferable that the schedule management method further includes a fifth step of changing the next scheduled time point included in the plural schedules each as an object for management in a range of the flexibility time zone in response to the request for schedule change to detect the residual time on the basis of the next scheduled time point changed.

Still furthermore, according to the present invention, a schedule management method is a schedule management method managing plural schedules in each of which a registration time zone and a first flexibility time zone showing a range in which the registration time zone can be changed are set, including: a first step of extracting plural schedules each as an object for management from the plural schedules in response to a request for schedule management; a second step of receiving a schedule whose adjustment is requested and which is composed of a desired time zone and a second flexibility time zone showing a range in which the desired time zone can be changed; a third step of comparing the schedule whose adjustment is requested with the plural schedules each as an object for adjustment to adjust such that the schedule whose adjustment is requested coincide with plural schedule setting enabling time zones of the plural schedules each as an object for adjustment; a fourth step of updating the plural schedules each as an object for adjustment when the schedule whose adjustment is requested coincides with the plural schedule setting enabling time zones; and a fifth step of originating a result of the adjustment in the third step, wherein a schedule setting enabling time zone is a time zone obtained by summing of an unassigned time zone and the first flexibility time zone, and in the third step, when the first flexibility time zone exceeds a limited time in the adjusted plural schedules each as an object for adjustment, a schedule as an object for adjustment to which the first flexible time zone exceeding is set is removed.

It is preferable that the plural schedules are schedules for use in managing a production process of a production line.

It is preferable that the plural schedules are schedules for use in managing production processes of production lines with respective different production capabilities.

Yet furthermore, according to the present invention, a schedule management apparatus includes: a schedule storage circuit storing plural schedules in each of which a registration time zone and a first flexibility time zone showing a range in which the registration time zone can be changed are set; a reception circuit receiving a schedule whose adjustment is requested and which is composed of a desired time zone and a second flexibility time zone showing a range in which the desired time zone can be changed; a schedule read circuit reading plural schedules each as an object for adjustment from the schedule storage circuit in response to a request for schedule adjustment received by the reception circuit; a schedule adjustment circuit comparing the schedule whose adjustment is requested with the plural schedules each as an object for adjustment to adjust such that the schedule whose adjustment is requested coincides with plural schedule setting enabling time zones of the plural schedules each as an object for adjustment; a schedule updating circuit updating each of the plural schedules each as an object for adjustment on the basis of the schedule whose adjustment is requested when the schedule whose adjustment is requested coincides with the plural schedule setting enabling time zones; a schedule rewrite circuit rewriting corresponding plural schedules stored in the storage circuit with the plural updated schedules updated by the schedule updating circuit; and an origination circuit originating a result of the adjustment effected by the schedule adjustment circuit, wherein a schedule setting enabling time zone is a time zone obtained by summing an unassigned time zone and the first flexibility time zone.

It is preferable that the schedule adjustment circuit adjusts such that the schedule whose adjustment is requested coincides with plural unassigned time zones by changing the desired time zone in a range of the second flexibility time zone when the desired time zone does not coincide with the plural unassigned time zones.

It is preferable that the schedule adjustment circuit adjusts such that the schedule whose adjustment is requested coincides with plural unassigned time zones by further changing each of plural unassigned time zones in a range of the corresponding first flexibility time zone when the schedule whose adjustment is requested does not coincides with the plural unassigned time zones even if the desired time zone is changed in a range of the second flexibility time zone.

It is preferable that the schedule adjustment circuit outputs a common time zone in which a schedule in common with the plural schedules each as an object for adjustment can be set when the schedule whose adjustment is requested does not coincides with the plural unassigned time zones even if the plural unassigned time zones are changed in ranges of the respective corresponding first flexibility time zones and the origination circuit originates the common time zone.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing a schedule adjustment system according to a first embodiment of the present invention;

FIG. 2 is a functional block diagram of a terminal device shown in FIG. 1;

FIG. 3 is a drawing of schedule constitution for describing a function of a mask processing circuit shown in FIG. 2;

FIG. 4 is a format of data transmitted from a server shown in FIG. 1;

FIG. 5 is a functional block diagram of a portable telephone shown in FIG. 1;

FIG. 6 is a format of a schedule;

FIG. 7 is a schedule for describing a schedule adjustment method according to the present invention;

FIG. 8 is a flow chart of a schedule adjustment method according to the first embodiment;

FIG. 9 is a screen image displayed on a portable telephone;

FIG. 10 is a screen image displayed on a portable telephone;

FIG. 11 is another schematic block diagram showing the schedule adjustment system according to a first embodiment of the present invention;

FIG. 12 is a functional block diagram of a terminal device shown in FIG. 11;

FIG. 13 is a functional block diagram of a portable telephone shown in FIG. 11;

FIG. 14 is a functional block diagram of a satellite shown in FIG. 11;

FIG. 15 is still another schematic block diagram showing the schedule adjustment system according to a first embodiment;

FIG. 16 is a map for describing a difference in travel time from a start place to a destination according to a second embodiment;

FIG. 17 is a schematic block diagram showing a schedule management system according to the second embodiment;

FIG. 18 is a schematic block diagram of a terminal device shown in FIG. 17;

FIG. 19 is a flow chart of a schedule management method according to the second embodiment;

FIG. 20 is another flow chart of the schedule management method according to the second embodiment;

FIG. 21 is still another flow chart of the schedule management method according to the second embodiment;

FIG. 22 is a schedule of a semiconductor production line according to a third embodiment;

FIG. 23 is a drawing for describing partial exposure by an exposure device; and

FIGS. 24A and 24B are plan views of semiconductor wafers each showing a chip region.

### DESCRIPTION OF THE PREFERRED EMBODIMENTS

Detailed description will be given of embodiments of the present invention below referring to the accompanying drawings. The same symbols, in the figures, are attached to the same or corresponding constituents and any of descriptions thereof is not repeated.

First Embodiment

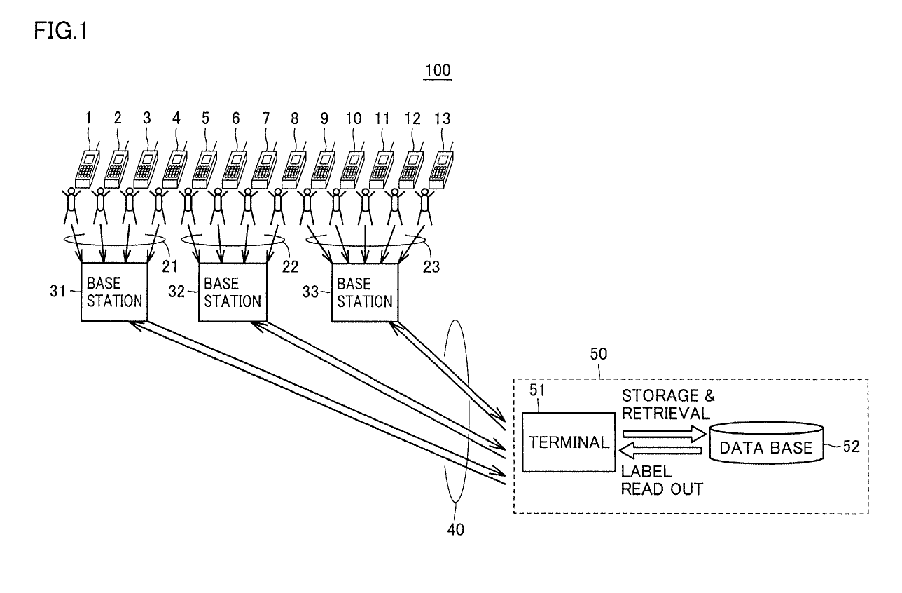

FIG. 1 is a schematic block diagram of a schedule management system using a schedule adjustment method and a schedule management apparatus according to a first embodiment of the present invention.

A schedule management system 100 includes: portable telephones 1 to 13; networks 21 to 23; base stations 31 to 33; a network 40; and a sever 50. The server 50 includes: a terminal device 51; and a data base 52.

The portable telephones 1 to 4 are connected to the base station 31 through the wireless network 21. The portable telephones 5 to 8 are connected to the base station 32 through the wireless network 22. The portable telephones 9 to 13 are connected to the base station 33 through the wireless network 23. The base stations 31 to 33 are connected to the server 50 through the network 40.

Users of the portable telephones 1 to 13 transmit respective schedules thereof to the server 50 through the corresponding networks 21 to 23, the corresponding base stations 31 to 33 and the network 40. The terminal device 51 of the server 50 receives the schedules from the portable telephones 1 to 13 and registers the received schedules on the data base 52. Furthermore, when the terminal device 51 receives a schedule to be adjusted from one of the portable telephones 1 to 13, the terminal device 51 reads a schedule as an object for adjustment from the data base 52 and adjustment is performed such that the schedule to be adjusted coincides with an unassigned time of a schedule as an object for adjustment. The terminal device 51 not only writes the adjusted schedules on the data base 52 for schedule updating, but also transmits information that the schedules have been adjusted to the portable telephone 1 to 13 of the users whose schedule each are an object for adjustment through the network 40, the base stations 31 to 33 and the networks 21 to 23. The data base 52 stores schedules of the users of the respective portable telephones 1 to 13. Note that the server 50 transmits/receives encrypted cipher data to/from the portable telephones 1 to 13.

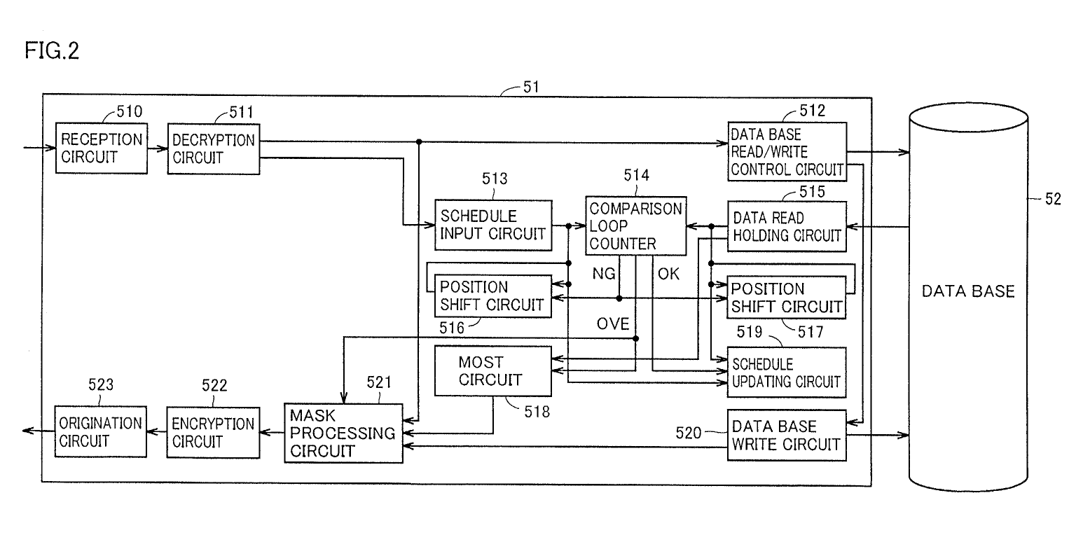

Referring to FIG. 2, the terminal device 51 includes: a reception circuit 510; a decryption circuit 511; a data base read/write control circuit 512; a schedule input circuit 513; a comparison loop counter 514; a data read holding circuit 515; position shift circuits 516 and 517; a MOST circuit 518; a schedule updating circuit 519; a data base write circuit 520; a mask processing circuit 521; an encryption circuit 522; and an origination circuit 523.

The reception circuit 510 receives a schedule whose adjustment is requested from one of the portable telephones 1 to 13 through the network 40. Note that the schedule whose adjustment is requested is encrypted. The decryption circuit 511 holds a secrete key Sk held by the portable telephones 1 to 13 and a public key Pk asymmetrical with the secret key Sk, and decrypts cipher data encrypted with the secrete key Sk in the portable telephones 1 to 13 using the public key Pk. That is, a public key cryptosystem is adopted in the schedule management system 100. The decryption circuit 511 outputs an address of a client whose schedule is an object for adjustment to the data base read/write control circuit 512 and the mask processing circuit 521. The data base read/write control circuit 512 receives the address of a client whose schedule is an object for adjustment among data decrypted by the decryption circuit 511 from the decryption circuit 511 and controls the data base 52 so as to read out a schedule corresponding to the received address. Furthermore, the data base read/write control circuit 512 controls the data base write circuit 520. The schedule input circuit 513 receives a decrypted schedule whose adjustment is requested from the decryption circuit 511 to output the received decrypted schedule whose adjustment is requested to the comparison loop counter 514, the position shift circuit 516 and the schedule updating circuit 519.

The comparison loop counter 514 compares the schedule whose adjustment is requested from the schedule input circuit 513 with a schedule as an object for adjustment from the data read holding circuit 515 to output a coincidence signal OK to the schedule updating circuit 519 if the schedule whose adjustment is requested coincides with an unassigned time of the schedule as an object for adjustment. On the other hand, the comparison loop counter 514 outputs a non-coincidence signal NG to the position shift circuits 516 and 517 if the schedule whose adjustment is requested does not coincide with an unassigned time of the schedule as an object for adjustment. Furthermore, the comparison loop counter 514 compares the schedule whose adjustment is requested changed by the position shift circuit 516 in a flexibility time zone with the schedule as an object for adjustment changed by the position shift circuit 517 in a flexibility time zone after outputting the non-coincidence signal NG; and outputs the coincidence signal OK to the schedule updating circuit 519 if the schedule whose adjustment is requested after the change coincides with an unassigned time of the schedule as an object for adjustment after the change, while outputting the non-coincidence signal NG to the position shift circuits 516 and 517 if in no-coincidence. The comparison loop counter 514 repeats an operation of comparing the schedule whose adjustment is requested changed by the position shift circuit 516 with the schedule as an object for adjustment changed by the position shift circuit 517 a predetermined number of times and outputs an adjustment finish signal OVE to the MOST circuit 518 and the mask processing circuit 521 if the schedule whose adjustment is requested does not coincide with the schedule as an object for adjustment even after the repetition. Note that the number of the comparison operations in the comparison loop counter 514 is determined depending on the number of changes in the schedule whose adjustment is requested or the schedule as an object of adjustment in a flexibility time zone described later.

The data read holding circuit 515 reads a schedule as an object for adjustment from the data base 52 and outputs the read-out schedule as an object for adjustment to the comparison loop counter 514, the position shift circuit 517 and the schedule updating circuit 519. When the position shift circuit 516 receives a non-coincidence signal NG from the comparison loop counter 514, the position shift circuit 516 changes a schedule whose adjustment is requested inputted from the schedule input circuit 513 a prescribed number of times in a flexibility time zone described later to output the changed schedule whose adjustment is requested to the comparison loop counter 514. When the position shift circuit 517 receives the non-coincidence signal NG from the comparison loop counter 514, the position shift circuit 517 changes a schedule as an object for adjustment inputted from the data read holding circuit 515 a prescribed number of times in a flexibility time zone described later to output the changed schedule as an object for adjustment to the comparison loop counter 514.

When the MOST circuit 518 receives an adjustment finish signal OVE from the comparison loop counter 514, the MOST circuit 518 detects a common unassigned time common to plural schedules each as object for adjustment inputted from the data read holding circuit 515 to output the detected common unassigned time to the mask processing circuit 521. When the schedule updating circuit 519 receives a coincidence signal OK from the comparison loop counter 514, the schedule updating circuit 519 updates the plural schedules each as an object for adjustment inputted from the data read holding circuit 515 according to a schedule whose adjustment is requested inputted from the schedule input circuit 513. The data base write circuit 520 not only rewrites a schedule as an object for adjustment stored in the data base 52 according to an updated schedule inputted from the schedule updating circuit 519, but also outputs the updated schedule to the mask processing circuit 521.

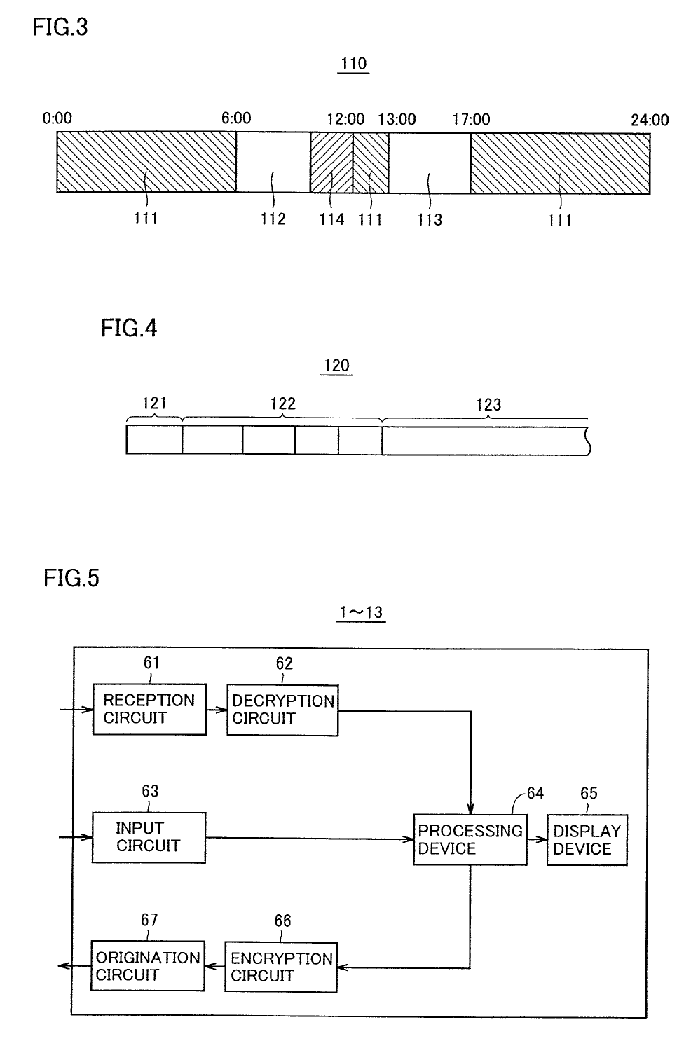

The mask processing circuit 521 outputs the adjustment finish signal OVE from the comparison loop counter 514, a schedule having a masked portion not to be laid open to a third party among the updated schedules inputted from the data base write circuit 520 and the common, unassigned time inputted from the MOST circuit 518 to the encryption circuit 522. In this case, the mask processing circuit 521 unconditionally masks a private time 111 of each client in a schedule 110 shown in FIG. 3 and further performs masking of a schedule 114 dependent on a reception party. That is, the mask processing circuit 521 does not perform masking of the schedule 114 to a party participating in the schedule adjustment but performs masking of the schedule 114 to clients other than the party participating in the schedule adjustment. Furthermore, the mask processing circuit 521 does not mask unassigned time zones 112 and 113 unconditionally. The mask processing circuit 521 outputs the partially masked schedule 110 according to a format shown in FIG. 4 to the encryption circuit 522. That is, data 120 is composed of a header 121, a code region 122 and a data region 123. Written in the header 121 are information on open to the public or not open to the public in regard to plural schedules written in the data region 123. Written in the code region 122 is a user code of each client originating the data 120. Written in the data region 123 is a schedule of a client corresponding to the user code. The mask processing circuit 521 writes an address of a client of a schedule as an object of adjustment inputted from the decryption circuit 511 as a user code and further writes the updated schedule inputted from the data base write circuit 520 into the data region 123 in correspondence to the address in the code region 122. By transmitting a schedule to the portable telephones 1 to 13 according to the format of the data 120, the portable telephones 1 to 13 can extract the schedule corresponding to a user code inputted to the data region 123 using the user code written into the code region 122.

The encryption circuit 522 holds the secrete key Ss and encrypts a schedule inputted from the mask processing circuit 521 and a common unassigned time zone to output the cipher data to the origination circuit 523. The origination circuit 523 originates the cipher data from the encryption circuit 522 to the portable telephones 1 to 13 through the network 40, the base stations 31 to 33 and the networks 21 to 23.

Referring to FIG. 5, each of the portable telephones 1 to 13 includes: a reception circuit 61, a decryption circuit 62, an input circuit 63, a processing device 64, a display device 65, encryption circuit 66 and an originating circuit 67.

The reception circuit 61 receives cipher data from the server 50 through the network 40, the base stations 31 to 33 and the networks 21 to 23. The decryption circuit 62 holds a secret key Ss and a public key Ps asymmetrical with the secrete key Ss held by the server 50 and decrypts the cipher data received by the reception circuit 61 using the public key Ps. The input circuit 63 receives an instruction, a schedule to be adjusted and others from the users of the portable telephones 1 to 13. The processing device 64 receives a schedule from the server 50 decrypted by the decryption circuit 62, a common unassigned time zone and a schedule whose adjustment is requested inputted from the input circuit 63 to output the schedule from the server 50 and the common unassigned time zone to the display device 65 and further outputs the schedule whose adjustment is requested to the encryption circuit 66. The display device 65 displays the schedule from the server 50 and the common unassigned time zone.

The encryption circuit 66 encrypts a schedule whose adjustment is requested with the secret key Sk that the circuit 66 holds to output cipher data to the origination circuit 67. The origination circuit 67 originates the cipher data to the server 50 through the networks 21 to 23, the base stations 31 to 33 and the network 40.

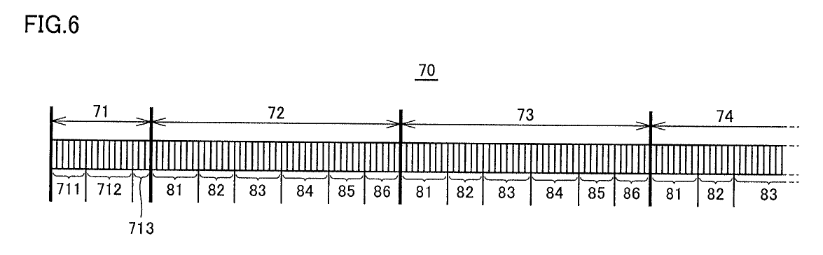

Referring to FIG. 6, description will be given of a data format of a schedule stored in the data base 52. A schedule 70 is composed of a header region 71 and data regions 72, 73, 74, . . . . The header region 71 is composed of a header 711, a group 712 and a contents header 713. A user address of a client is written in the header 711. A group number of a client to which the client belongs is written in the group 712. The number of the data regions is written in the contents header 713. Note that when a schedule 70 is transmitted to another client, the group 712 is not laid open to the public. The reason for this is that schedules of clients are in many cases adjusted and managed with one group as a unit and when the schedule 70 is transmitted to a client of another group, there also arises a case where the transmitted schedule 70 is desired not to be known of which group a client associated with the schedule 70 belongs to. On the other hand, when the schedule 70 is transmitted to another client in the same group, the group number is information with no meaning. Therefore, the group 712 is handled so as not to be laid open to the public in all aspects.

Each of the data regions 72, 73, 74, . . . is composed of a schedule header 81, a group 82, a start time point 83, an end time point 84, a flexibility start time point 85 and a flexibility end time point 86. Each of the data regions 72, 73, 74, . . . is a specification showing one schedule. A flag or a title is written in the schedule header 81. The flag indicates whether or not a schedule written in each of the data regions 72, 73, 74, . . . should be laid open to the public. A group number to which a client belongs is written in the group 82. The start time point 83 is a time point indicating the start of one schedule. The end time point 84 is a time point indicating the end of one schedule. The flexibility start time point 85 is a time point indicating the start of a range in which the start time point 83 or the end time point 84 can be changed. The flexibility end time point 86 is a time point indicating the end of a range in which the start time point 83 or the end time point 84 can be changed. The schedule 70 shows a schedule of one client and plural schedules corresponding to respective plural client are stored in the data base 52 each in the format of the schedule 70.

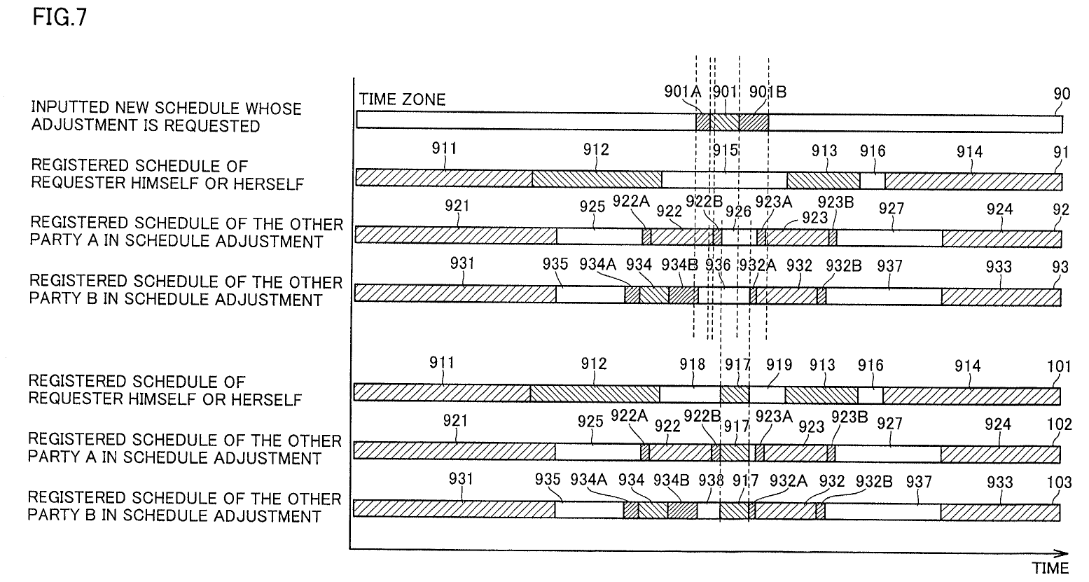

Referring to FIG. 7, description will be given of a method for adjusting a schedule of a client according to the first embodiment. FIG. 7 shows a case where a requester requesting schedule adjustment adjusts a schedule the requester desires to be registered in the data base 52 of the server 50 to schedules of two clients A and B. A schedule 90 whose adjustment is requested is composed of a desired time zone 901 in which the requester desires to be registered, flexibility time zones 901A and 901B. The flexibility time zones 901A and 901B each indicate a range in which the desired time zone 901 can be changed. In such a manner, the requester sets the flexibility time zones 901A and 901B in which the desired time zone 901 can be changed for the desired time zone 901 in which the requester desires schedule registration to be performed and requests the server 50 that adjustment is performed to the schedules of the clients A and B.

The schedule 91 as an object for adjustment is a schedule of the requester himself, or herself, the schedule 92 as an object for adjustment is a schedule of the client A and the schedule 93 as an object for adjustment is a schedule of the client B. The schedule 91 as an object for adjustment is composed of schedules 911 to 914, and unassigned time zones 915 and 916. The schedule 92 as an object for adjustment is composed of schedules 921 to 924, and unassigned time zones 925 to 927. Flexibility time zones 922A and 922B are set for the schedule 922 and flexibility time zones 923A and 923B are set for the schedule 923. The schedule 93 as an object for adjustment is composed of schedules 931 to 934, and unassigned time zones 935 to 937. Flexibility time zones 932A and 932B are set for the schedule 932 and flexibility time zones 934A and 934B are set for the schedule 934.

The schedules 911, 914, 921 to 924, and 931 to 933 are schedules, such as a private time, not to be desired to be laid open to third parties. The schedules 912, 913 and 934 are schedules to be laid open or not to be laid open according to a third party. For example, while a schedule is laid open to the other party with whom the schedule is adjusted, the schedule is not to be laid open to all of third parties.

The schedule 90 as an object for adjustment is set in part of the unassigned time zone 915 of the schedule 91 as an object for adjustment which is the schedule of the requester. The desired time zone 901 of the schedule 90 whose adjustment is requested partly overlaps the schedule 922 of the schedule 92 as an object for adjustment and is set in part of the unassigned time zone 936 of the schedule 93 as an object for adjustment. Therefore, in this situation, the schedule 90 whose adjustment is requested cannot be registered. Therefore, the desired time zone 901 of the schedule 90 whose adjustment is requested is changed in the ranges of the flexibility time zones 901A and 901B, and the desired time zone 917 after the change is adjusted so as to be set in a range of the unassigned time zones of the schedules 92 and 93 each as an object for adjustment or in a range obtained by adding the flexibility time zones of the schedules 92 and 93 to the unassigned time zones of the schedules 92 and 93. To be concrete, the procedure goes this way: when the desired time zone 901 is changed in a range of the flexibility time zone 901A, an increase occurs in overlap with the schedule 922 of the schedule 92 as an object of adjustment; therefore, the desired time zone 901 cannot be changed in the range of the flexibility time zone 901A. On the other hand, when the desired time zone 901 is changed in a range of the flexibility time zone 901B, the desired time zone 901 can be set in a range of the unassigned time zone 926 of the schedule 92 as an object of adjustment and in a range for the unassigned time range 936 of the schedule 93 as an object for adjustment. Therefore, the desired time zone 901 is changed in a range of the flexibility time zone 901B such that the start time point of the desired time zone 901 coincides with the end time point of the flexibility time zone 922B of the schedule 922 and that the end point of the desired time zone 901 coincides with the start time point of the flexibility time zone 932A of the schedule 932. According to such a procedure, the desired time zone 917 after the change can be set in the ranges of the unassigned time zone 915 of the schedule 91 as an object for adjustment, the unassigned time zone 926 of the schedule 92 as an object for adjustment and the unassigned time zone 936 of the schedule 93 as an object for adjustment.

Then, the desired time zone 917 after the change is set in each of the schedules 91 to 93 each as an object for adjustment to generate undated schedules 101 to 103. The updated schedule 101 is an updated schedule of the requester, the updated schedule 102 is an updated schedule of the client A and the updated schedule 103 is an updated schedule of the client B. The updated schedule 101 is composed of schedules 911 to 914 and the schedule 917, and unassigned time zone 916, 918 and 919. The updated schedule 102 is composed of the schedules 917 and schedules 921 to 924, and unassigned time zones 925, 927 and 928. The updated schedule 103 is composed of the schedules 917 and schedules 931 to 934, and unassigned time zones 935, 937 and 938. Note that the newly set schedule 917 is a schedule to be laid open or not to be laid open to the public according to third parties.

As described above, the desired time zone 901 was changed using the flexibility time zone 901B set in the schedule 90 whose adjustment is requested to perform adjustment to the schedules 92 and 93 of the clients A and B. When adjustment to a schedule of another client as the other party can not be performed even using a flexibility time zone set in an schedule whose adjustment is requested, the adjustment is performed by changing a schedule of the other party to which the adjustment is performed in a range of a flexibility time zone set in the schedule of the other party as an object for adjustment. For example, when the schedule 90 whose adjustment is requested cannot avoid overlap with the schedules 922 and 932 of the schedules 92 and 93 each as an object for adjustment even if the desired time zone 901 is changed in ranges of the flexibility time zones 901A and 901B; then, the schedule 922 is changed in ranges of the flexibility time zones 922A and 922B, or the schedule 932 is changed in ranges of the flexibility time zones 932A and 932B for the purpose of the adjustment.

Furthermore, when schedule adjustment cannot be performed even if a desired registration time is changed using flexibility time zones set for a schedule whose adjustment is requested and in addition, a schedule as an object for adjustment of the other party to which adjustment is performed is changed using a flexibility time zone set in the schedule as an object for adjustment, an unassigned time zone common to plural schedules each of an object for adjustment is detected and the detected common unassigned time zone is transmitted to a requester of the adjustment.

In adjustment of a schedule according to the present invention, that the desired time zone 901 is changed in the ranges of the flexibility time zones 901A and 901B for schedule adjustment corresponds to a procedure that a changed desired time zone is made to coincide with a time zone (referred to as “a schedule setting enabling time zone”) obtained by adding the flexibility time zones 922B and 923A; and 932A and 934B of the respective schedules 922, 923; and 932 and 934 to the unassigned time zones 926 and 936 of the respective schedules 902 and 903. Therefore, the unassigned time zones 926 and 936 use the flexibility time zones 922B, 923A, 932A and 934B of the adjacent schedules 922, 923, 932, and 934 as flexibility time zones showing variable ranges of the unassigned time zones.

In such a manner, the present invention is characterized by changing a desired time zone in which registration is desired or schedules of the other parties to which adjustment are performed using flexibility time zones to adjust plural schedules.

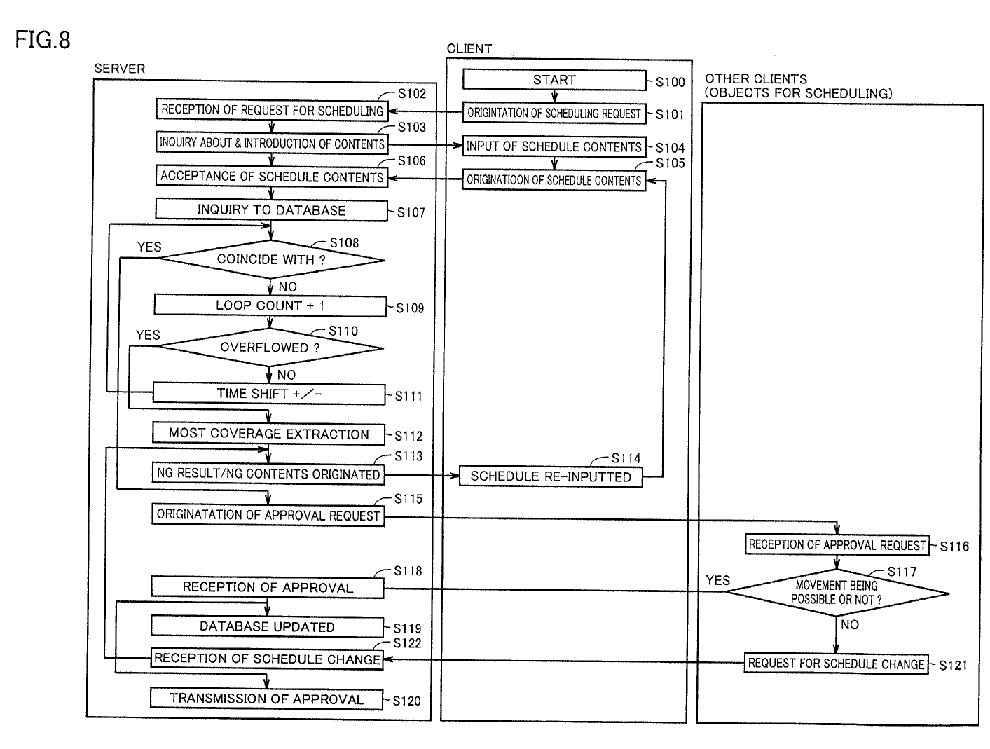

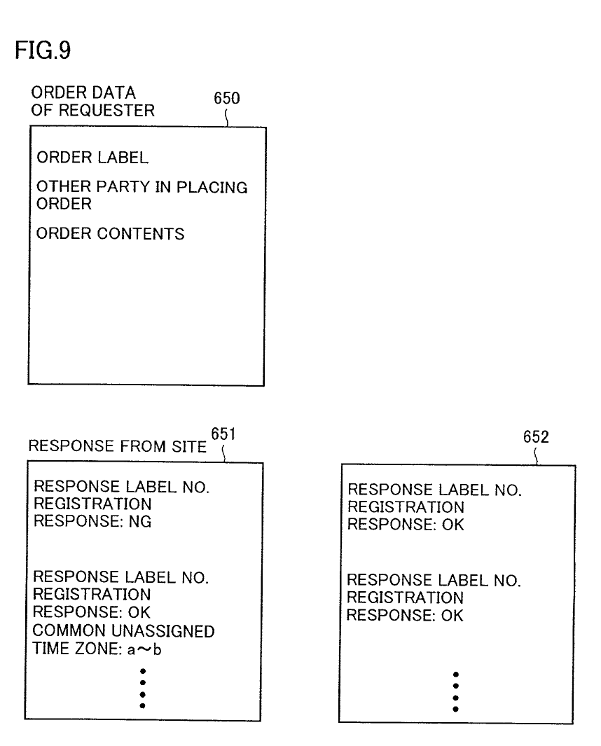

Referring to FIG. 8, description will be given of a flow chart of a schedule adjustment method according to the present invention. When an adjustment operation gets started (step S100), a client originates a request for schedule adjustment using of one of the portable telephones 1 to 13 owned by the client to the server 50 (step S101). The terminal device 51 of the server 50 receives and accepts the request for schedule adjustment through the networks 21 to 23, the base stations 31 to 33 and the network 40 (step S102). When a control circuit (not shown) of the terminal device 51 accepts the request for schedule adjustment, the control circuit outputs an inquiry about adjustment contents to the origination circuit 523 and the origination circuit 523 originates the adjustment contents to a client (step S103). The reception circuit 61 of one of the portable telephones 1 to 13 receives the inquiry about the adjustment contents to output the inquiry about the adjustment contents to the processing device 64 through decryption circuit 62. The processing device 64 displays the inputted inquiry about the adjustment contents on the display device 65. Thereby, the client is notified that the inquiry about the adjustment contents has been issued and inputs a user address of the other party to whose schedule adjustment is performed and a schedule whose adjustment is requested to the one of the portable telephones 1 to 13 from the input circuit 63 (step S104). In this case, a screen image 650 is displayed, as shown in FIG. 9, on the display device 65 of the one of the portable telephones 1 to 13 and the client inputs the user address of the other party to whose schedule adjustment is performed as a party with whom to place an order while watching the screen image 650 and further inputs a schedule 90 whose adjustment is requested as contents of an order.

Referring to FIG. 8, the client confirms the order contents using the screen image 650 and thereafter, inputs an originating instruction from the input circuit 63. When the processing device 64 receives the originating instruction from the input circuit 63, the processing device 64 receives the order contents from the display device 65 to output the order contents to the encryption circuit 66. The encryption circuit 66 encrypts the order contents with the secret keys Sk to output cipher order contents to the origination circuit 67. The origination circuit 67 originates the cipher order contents to the server 50 (step S105). The terminal device 51 of the server 50 receives and accepts the cipher order contents with the reception circuit 510 through the networks 21 to 23, the base stations 31 to 33 and the network 40 (step S106). The decryption circuit 511 decrypts the cipher order contents with the public key Pk to output the user address of the other party to whose schedule adjustment is performed to the data base read/write control circuit 512 and further outputs the schedule 90 whose adjustment is requested to the schedule input circuit 513. The schedule input circuit 513 outputs the schedule 90 whose adjustment is requested to the comparison loop counter 514, the position shift circuit 516 and the schedule updating circuit 517. The data base read/write control circuit 512 controls the data base 52 such that schedules 91 to 93 each as an object for adjustment of the other parties participating in the adjustment in each of which schedules a user address (a user address written in the header 711 of the schedule 70 shown in FIG. 6) coinciding with the inputted user address is written are outputted.

The data read holding circuit 515 reads the schedules 91 to 93 each as an object for adjustment from the data base 52 to output the read-out schedules 91 to 93 each as an object for adjustment to the comparison loop counter 514, the position shift circuit 517, the MOST circuit 518 and the schedule updating circuit 519. By doing so, the comparison loop counter 514 compares the schedule 90 whose adjustment is requested with the schedules 91 to 93 each of an object for adjustment to judge whether or not a desired time zone 901 of the schedule 90 whose adjustment is requested coincides with the unassigned time zones 915, 926 and 936 of the schedules 91 to 93 each as an object for adjustment (step S108). When the desired time zone 901 coincides with the unassigned time zones 915, 926 and 936, the process goes to the step S115. When it is judged that the desired time zone 901 does not coincide with the unassigned time zones 915, 926 and 936 in step S108, the comparison loop counter 514 increments a loop count value by [1] (step S109). The comparison loop counter 514 judges whether or not an adjustment operation has been overflowed (step S110). That is, the comparison loop counter 514 counts the number of adjustment times of a schedule in loop count value and when a loop count value amounts to a preset number of adjustment times, the adjustment finish signal OVE indicating that the adjustment operation has been overflowed is outputted.

In step S110, if it is judged that a loop count value has not amounted to a setting value, the comparison loop counter 514 outputs a non-coincidence signal NG showing that the desired time zone 901 does not coincide with the unassigned time zones 915, 926 and 936 to the position shift circuit 516. Then, the position shift circuit 516 receives the non-coincidence signal NG to change the desired time zone 901 of the schedule 90 whose adjustment is requested inputted from the schedule input circuit 513 in the ranges of the flexibility time zones 901A and 901B and output the desired time zone 917 obtained by the change to the comparison loop counter 514 (step S1).

Thereafter, steps S108 to S111 are repeated and if it is judged by the comparison loop counter 514 that the desired time zone 917 coincides with the unassigned time zones 915, 926 and 936 in step S108, the comparison loop counter 514 outputs a coincidence signal OK to the schedule updating circuit 519. Thereafter, the schedule updating circuit 519 writes the desired time zone 917 into the schedules 91 to 93 each as an object for adjustment to update the schedules 91 to 93 each as an object for adjustment and output the updated schedules 101 to 103 to the data base write circuit 520. The data base write circuit 520 outputs the updated schedules 101 to 103 to the mask processing circuit 521. The mask processing circuit 521 masks a portion not to be laid open to the public of each of the updated schedules 101 to 103. The encryption circuit 522 encrypts the updated schedules 101 to 103 with the secrete key Ss and the origination circuit 523 originates the cipher updated schedules 101 to 103 to some of the portable telephones 1 to 13 of the parties participating in the adjustment. That is, approval requesting origination that requests approvals for the adjusted schedules is performed to the parties participating in the adjustment (step S115).

On the other hand, when the comparison loop counter 514 judges that a loop count value has amounted to a setting value, the comparison loop counter 514 outputs an adjustment finish signal OVE to the MOST circuit 518. The MOST circuit 518 detects a common unassigned time zone common to the schedules 91 to 93 as an object for adjustment on the basis of the schedules 91 to 93 each as an object for adjustment inputted from the data read holding circuit 515 to output the detected common unassigned time zone to the mask processing circuit 521 (step S112). Then, the mask processing circuit 521 outputs the common unassigned time zone to the encryption circuit 522, the encryption circuit 522 encrypts the common unassigned time zone with the secret key Ss and the origination circuit 523 transmits the encrypted common unassigned time zone to the some of the portable telephones 1 to 13 of the clients (step S113).

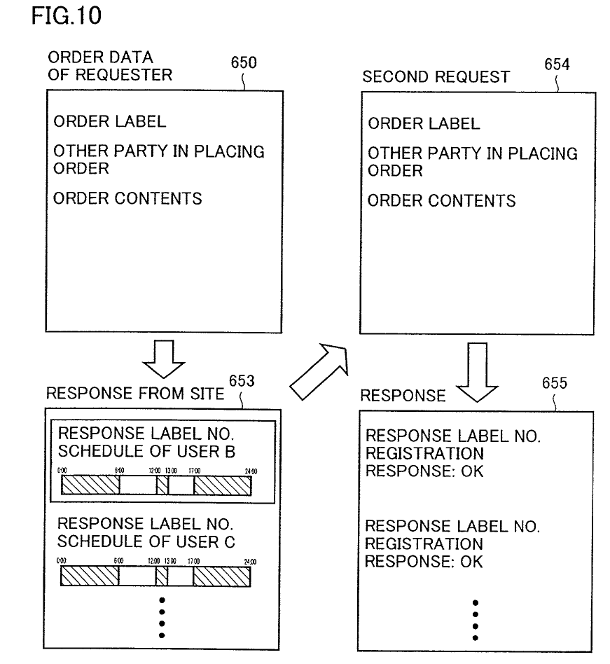

Then, the some of the portable telephones 1 to 13 of the clients receive the encrypted common unassigned time zone by the reception circuit 61 of each portable telephone and the decryption circuit 62 thereof decrypts the encrypted common unassigned time zone by the public key Ps to output a result of the decryption to the processing device 64. The processing device 64 displays the common unassigned time zone on the display device 65. In this case, a screen image 651 shown in FIG. 9 is displayed on the display device 65. That is, there are displayed a label number of a client whose schedule adjustment has been unsuccessful and a response result thereof, a label number of a client whose schedule adjustment has been successful and a response result thereof and a common unassigned time zone: a to b. The client sees the common unassigned time zone displayed on the display device 65 and inputs a schedule whose adjustment is requested which can be adjusted to schedules of all the other parties participating in the adjustment and an originating instruction into the portable telephones 1 to 13 from the input circuit 63 by means of the above described method (step S114). The processing device 64 receives an originating instruction from the input circuit 63 and acquires a newly inputted schedule whose adjustment is requested from the display device 65 to output the schedule to the encryption circuit 66. The encryption circuit 66 encrypts the new schedule whose adjustment is requested using the secrete key Sk to output the encrypted schedule to the origination circuit 67. The origination circuit 67 originates the encrypted schedule whose adjustment is requested to the server 50 (step S105). Thereafter, a process from steps S106 to S114 is repeated till schedule adjustment is completed and when the schedule adjustment has been completed in step S108, the process goes to step S115. In this case, when a schedule whose adjustment is requested is again inputted to perform adjustment of the schedule, screen images 650, 653, 654 and 655 shown in FIG. 10 are sequentially displayed on the display devices 65 of the portable telephones 1 to 13.

Referring to FIG. 8, after step S115, the portable telephones 1 to 13 of parties participating in schedule adjustment each receives an approval request through the reception circuit 61 of each portable telephone. The decryption circuit 62 decrypts the encrypted approval request with the public key Ps to output the decrypted approval request to the processing device 64. The processing device 64 accepts the approval request (step S116). Then, the processing device 64 displays updated schedules 102 and 103 on the display device 65, the parties participating in schedule adjustment see the newly set schedules and judge whether or not each of the participating parties can move to a newly set place at a newly set time point (step S117). If one of the parties participating in the schedule adjustment judge that the movement is impossible, the one of the participating parties inputs a request for schedule change to the one of the portable telephones 1 to 13 through the input circuit 63 thereof (step S121). The processing device 64 receives the request for schedule change from the input circuit 63 to output the request for schedule change to the encryption circuit 66. The encryption circuit 66 encrypts the request with the secret key Sk and the origination circuit 67 transmits the cipher request for schedule change to the server 50.

The terminal device 51 of the server 50 receives the request for schedule change through the reception circuit 510 (step S122). Thereafter, the process goes to step S113 and readjustment of the schedule using the common unassigned time zone is performed.

In step S117, if each of the parties participating in the adjustment judges that the movement is possible, the each participating party inputs an approval on the request for schedule change into one of the portable telephones 1 to 13 through the input circuit 63. The processing device 64 receives the approval from the input circuit 63 to output the approval to the encryption circuit 66. The encryption circuit 66 encrypts the approval with the secrete key Sk and the origination circuit 67 originates the encrypted approval to the server 50. The terminal device 51 of the server 50 receives the encrypted approval (step S118) and the decryption circuit 511 decrypts the encrypted approval with the public key Pk to output the decrypted approval to the data base read/write control circuit 512. When the data base read/write control circuit 512 receives the approval, the data base read/write control circuit 512 outputs the approval to the data base write circuit 520. When the data base write circuit 520 receives the approval, the data base write circuit 520 rewrites the schedules 91 to 93 each as an object for adjustment stored in the data base 52 according to updated schedules 101 to 103 (step S119). Thereafter, with the control of control circuit (not shown), the origination circuit 523 transmits information that the updating of the schedules has been approved to the requester and the other parties participating in the adjustment to terminate the adjustment operation for schedules (step S120). In this case, the screen image 652 shown in FIG. 9 are displayed on the display devices 65 of the portable telephones 1 to 13 of the requester and the other parties participating in the adjustment, whereby all the clients knows that the schedules thereof have been adjusted.

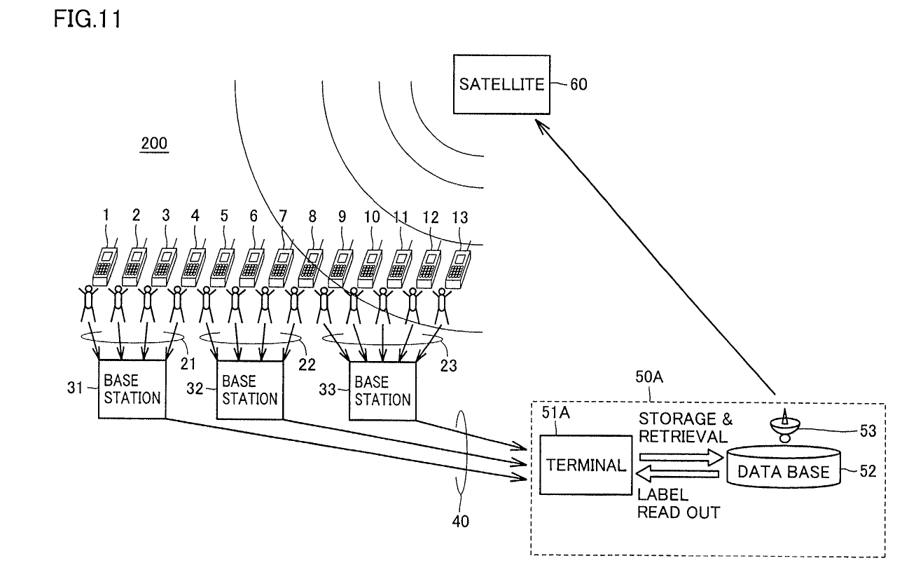

A schedule adjustment system in the embodiment is not limited to the schedule adjustment system 100 shown in FIG. 1, but may be a schedule adjustment system 200 shown in FIG. 11. The schedule adjustment system 200 is configured such that the server 50 of the schedule adjustment system 100 is replaced with a server 50A and the system 200 is added with a satellite 60, with the other constituents being the same as corresponding constituents of the schedule adjustment system 100.

The server 50A is configured such that the terminal device 51 of the server 50 shown in FIG. 1 is replaced with the terminal device 51A and an origination device 53 is added thereto and the other configuration is the same as that of the server 50. The schedule adjustment system 200 works such that a request for schedule adjustment from each client from the portable telephones 1 to 13 is received through the networks 21 to 23, the base stations 31 to 33 and the network 40 and a schedule adjusted by the server 50A is transmitted to the portable telephones 1 to 13 via the satellite 60. That is, the terminal device 51A receives a request for adjustment from one of the portable telephones 1 to 13, schedules of clients whose schedule is an object for adjustment are adjusted by means of the above described adjustment method and a result of the adjustment is outputted to the origination device 53. The origination device 53 originates an adjusted schedule to the satellite 60 and the satellite 60 receives the adjusted schedule. Then, the satellite 60 sends the adjusted schedule to all of the portable telephones 1 to 13. That is, in the schedule adjustment system 200, the schedules adjusted by the server 51A are transmitted even to a portable telephone of a client who does not participate in the adjustment.

The reason why the adjusted schedule is originated by the satellite 60 is that in a case where persons each of whose schedules is an object for adjustment are distributed over a wide range, a requester can transmit a request for adjustment to the server 51A through a nearest base station but it is a difficulty in terms of time, expense and others to transmit a schedule after adjustment by the server 51a to the persons each of whose schedules is an object for adjustment distributed across a wide area; therefore, there arises a desire to quickly transmit the adjustment result to the persons each of whose schedules is an object for adjustment. In this case, while the schedule after the adjustment is transmitted to a client other than the persons each of whose schedules is an object for adjustment, it is possible that only the persons each of whose schedules is an object for adjustment can be acquire the schedule after the adjustment if the new schedule is originated according to a data format shown in FIG. 4.

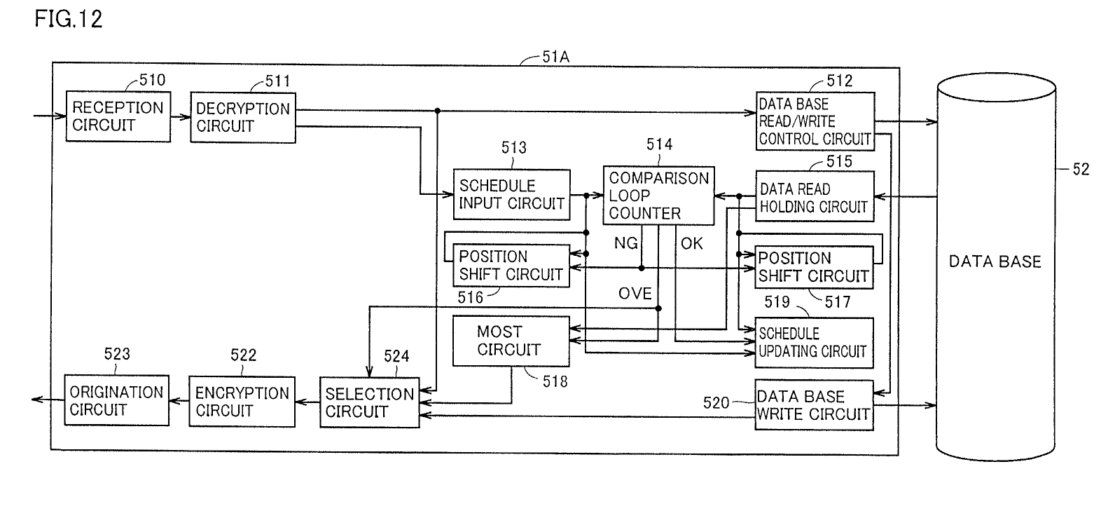

Referring to FIG. 12, the terminal device 51A is configured such that in the terminal device 51 shown in FIG. 2, the mask processing circuit 521 is replaced with selection circuit 524 and the other configuration is the same as that of the terminal device 51. The selection circuit 524 selects an adjustment finish signal OVE from the comparison loop counter 514, a common unassigned time zone from the MOST circuit 518 and an updated schedule from the data base write circuit 520 to output the data to the encryption circuit 522. The selection circuit 524 selects an updated schedule setting a correspondence with an address inputted from the decryption circuit 511 when selecting the updated schedule and outputs the data to the encryption circuit 522 in conformity with the format of the data 120 shown in FIG. 4. In this situation, the selection circuit 524 writes the following information into the header 121: information indicating which part of which of schedules is masked, that is information on to lay open or not to lay open to the public that are written in the data region, among schedules written in the data region 123.

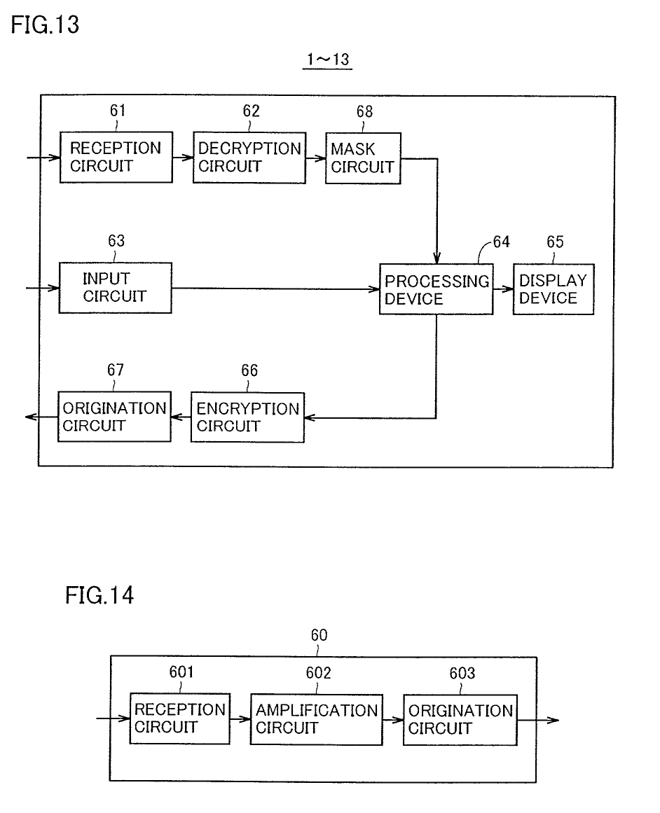

Referring to FIG. 13, the portable telephones 1 to 13 in the schedule adjustment system 200 shown in FIG. 11 are each constructed of functional blocks shown in FIG. 5 added with a mask circuit 68. The mask circuit 68 receives a schedule decrypted by the decryption circuit 62 as the data 120 shown in FIG. 4 and masks a corresponding part of a corresponding schedule on the basis of information on to lay open or not to lay open to the public written in the header 121 of the data 120 to output the partially masked data 120 to the processing device 64. That is, while in the schedule adjustment system 200, the server 51A transmits all of schedules without masking any part of each of the schedules to the portable telephones 1 to 13, in this case necessary masking is performed in the portable telephones 1 to 13.

Referring to FIG. 14, the satellite 60 includes a reception circuit 601, an amplification circuit 602 and an origination circuit 603. The reception circuit 601 receives data such as a schedule from the server 51A. The amplification circuit 602 amplifies data such as a schedule received by the reception circuit 601. The origination circuit 603 originates data amplified by the amplification circuit 602 to the portable telephones 1 to 13.

The other configuration of the system is the same as that in the schedule adjustment system 100. In the schedule adjustment system 200, schedules of plural clients are adjusted according to the flow chart shown in FIG. 8.

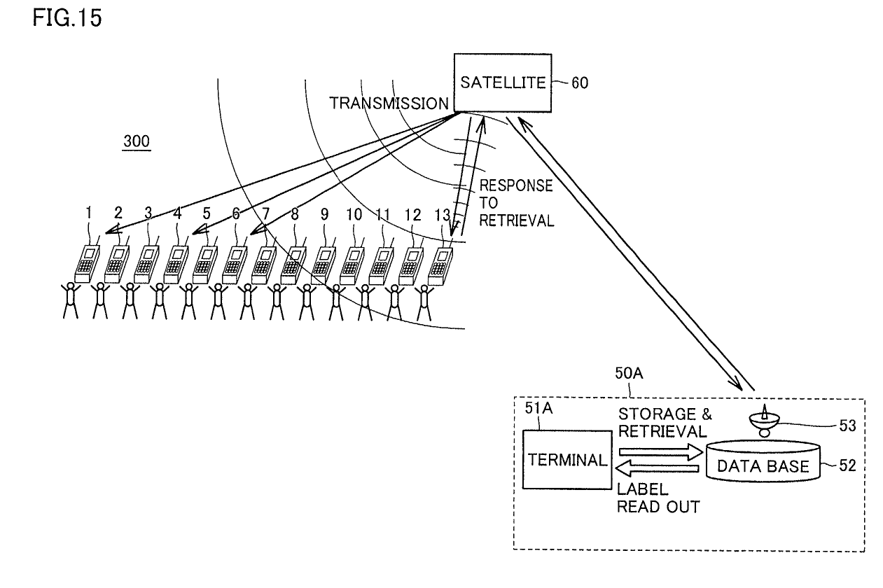

Furthermore, a schedule adjustment system in the first embodiment may be a schedule adjustment system 300 shown in FIG. 15. The schedule adjustment system 300 is configured such that communications between each of the portable telephones 1 to 13 and the server 50A are performed through the satellite 60. The other configuration in the system 300 is the same as in the schedule adjustment system shown in FIG. 11. With the use of the schedule adjustment system 300, schedule adjustment can be performed between clients spreading in a wider range than with the use of the schedule adjustment system 200.

According to the first embodiment, a server having received a request for schedule adjustment from a client compares a schedule whose adjustment is requested with a schedule as an object for adjustment, and if a desired time zone of the schedule whose adjustment is requested is not included in or does not coincide with an unassigned time zone of the schedule as an object for adjustment, the desired time zone is changed in a range of a flexibility time zone to adjust such that the desired time zone is included in an unassigned time zone of the schedule as an object for adjustment; therefore, schedules of plural clients can be automatically adjusted.

Second Embodiment

When the schedule adjustment systems 100 to 300 in the first embodiment are adopted, schedules of plural clients can be automatically adjusted and the adjusted schedules can be registered for updating.

When a client has forgotten a schedule registered on a data base for updating, the set schedule is not executed. In a case of a schedule associated with schedules of other plural clients, if the case happens, the schedule is not correctly executed, which results in inconveniences to the other plural clients.

Therefore, in the second embodiment, description will given of a schedule management system in which a schedule of each client is managed according to the schedule registered in a data base.

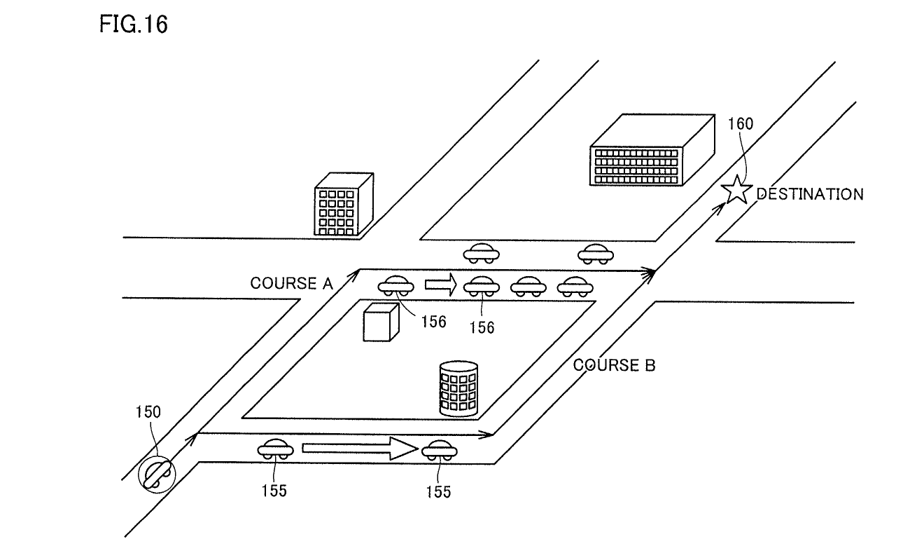

Referring to FIG. 16, a case is considered in which a client moves from a start place 150 to a destination 160 till a next scheduled time point. The client rides in a car and there are available courses A and B to go to the destination 160. The client has no knowledge on which course, selected by the client, of the courses A and B can take the client to the destination 160 faster the other at a time point that the client is at the start place 150. This is because the client has no information on traffic conditions on the courses A and B. Therefore, a server in a schedule management system receives a current position of the client from a portable telephone that the client carries and specifies the course A or B up to the destination 160. Then, the server calculates a moving speed of the car on the specified course A and B according to a method described later to detect a travel time from the start place 150 to the destination 160. The server extracts a next scheduled time point on the basis of the schedule of the client to calculate a residual time to the next scheduled time point from a current time point. The server further notifies the client that the client should move toward the destination 160 when a difference in time obtained by subtracting the travel time from the calculated residual time is equal to or less than a prescribed value.

In the case shown in FIG. 16, the client should select the course B since the moving speed is higher on the course B than on the course A. However, as far as the client stays at the start place 150, no knowledge is available to the client on moving speeds on the respective courses A and B. Therefore, the server receives satellite photographs shot by the satellite showing traffic conditions on the respective courses A and B at prescribed time intervals from the satellite to calculate the moving speeds of the car on the courses A and B on the basis of the received satellite photographs. That is, attention is paid to one cars 155 and 156 on the respective courses A and B in photographs shot at prescribed intervals and moving distances of the cars 155 and 156 in each of the prescribed intervals are calculated from satellite photographs, thereby estimating moving speeds of the client's car on the courses A and B.

Moving speeds of the cars 155 and 156 on the respective courses A and B can also be calculated in a similar manner from photographs shot by surveillance cameras installed on and along a road without depending on satellite photographs.

Note that the client is required to transmit a current position thereof and the current position is detected by the use of a car navigation system equipped on the car to transmit the current position to the server. Furthermore, a current position of the car of a client may be detected by GPS (Global Positioning System).

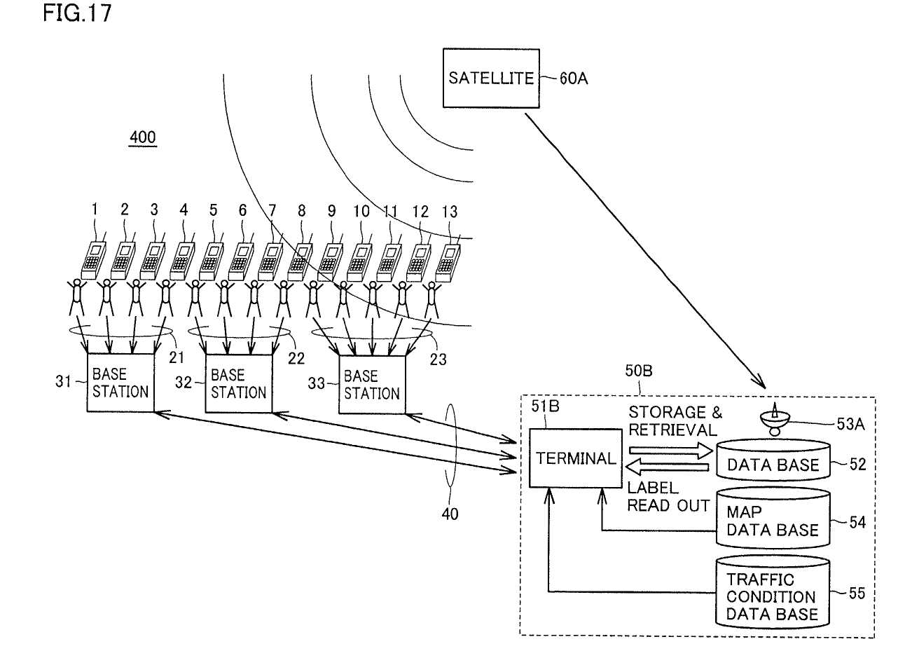

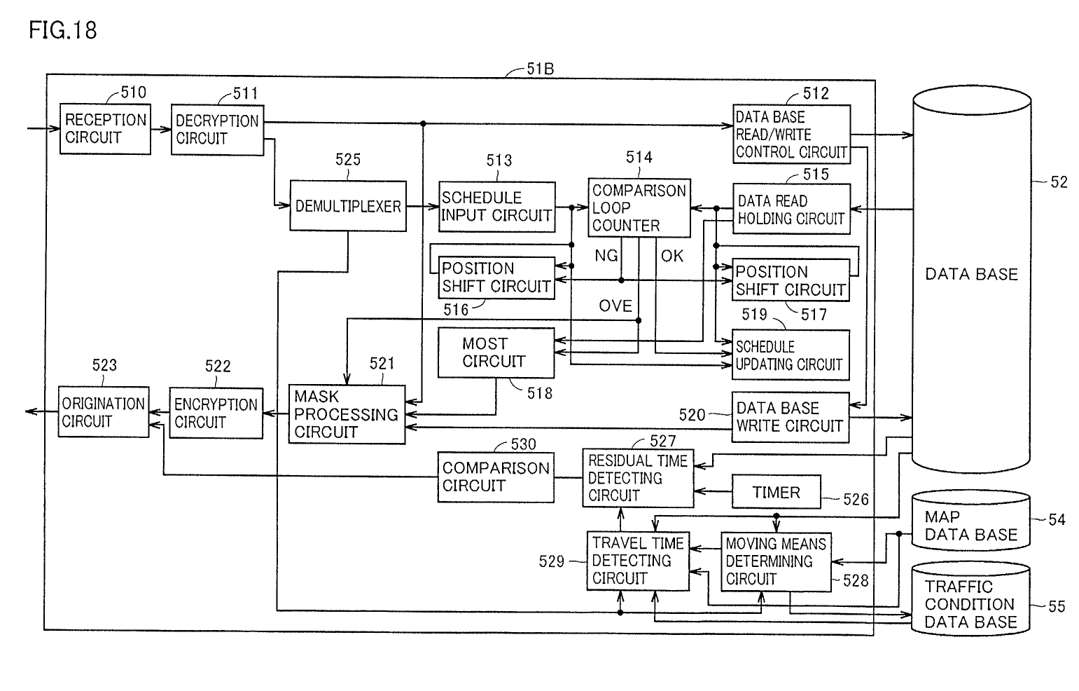

Referring to FIG. 17, a schedule management system 400 in the second embodiment is configured such that in the schedule adjustment system 200 shown in FIG. 11, the server 50A is replaced with a server 50B and the satellite 60 is replaced with a satellite 60A, wherein the portable telephones 1 to 13 can be bidirectionally communicated with the server 50B.

The server 50B includes a terminal device 51B, a data base 52, a reception device 53A, a map data base 54 and a traffic condition data base 55. The map data base 54 stores maps of geographical areas. The traffic condition data base 55 stores traffic conditions shot by the satellite 60A. The terminal device 51B calculates a travel time from a start place to a destination by means of a method described later using a map from the map data base 54 and a traffic condition from the traffic condition data base 55 to transmit a course A or B to be selected and a signal of urging to move to the portable telephone 1 to 13 of the client when the above described difference in time becomes equal to or less than a prescribed time. The reception device 53A receives satellite photographs transmitted from the satellite 60A to store the photographs into the traffic condition data base 55. The data base 52 is the same as that described in the first embodiment.

Referring to FIG. 18, a terminal device 51B includes: a reception circuit 510; a decryption circuit 511; a data base read/write control circuit 512; a schedule input circuit 513; a comparison loop counter 514; a data read holding circuit 515; position shift circuits 516 and 517; a MOST circuit 518; a schedule updating circuit 519; a data base write circuit 520; a mask processing circuit 521; an encryption circuit 522; an origination circuit 523; a demultiplexer 525; a timer 526; a residual time detecting circuit 527; a moving means determining circuit 528; a travel time detecting circuit 529; and a comparison circuit 530. The same descriptions as in the first embodiment apply to the reception circuit 510, the decryption circuit 511, the data base read/write control circuit 512, the schedule input circuit 513, the comparison loop counter 514, the data read holding circuit 515, the position shift circuits 516 and 517, the MOST circuit 518, the schedule updating circuit 519, the data base write circuit 520, the mask processing circuit 521, the encryption circuit 522 and the origination circuit 523.

The multiplexer 525 outputs a schedule whose adjustment is requested among data from the decryption circuit 511 to the schedule input circuit 513 and further outputs a current position of the client to the moving means determining circuit 528 and the travel time detecting circuit 529. The timer 526 outputs time information to the residual time detecting circuit 527. The residual time detecting circuit 527 detects a residual time from a current time point to the next scheduled time point on the basis of a schedule as an object for management outputted from the data base 52 and the current time point from the timer 526; and further detects a difference in time obtained by subtracting a travel time from the residual time, using the travel time from the travel time detecting circuit 529, to output the residual time or the difference in time to the comparison circuit 530. The moving means determining circuit 528 reads out a map on which a current place and a destination are shown from the map data on the basis of the current position of the client inputted from the demultiplexer 525 and a destination included in a schedule as an object for management from the data base 52, thereby determining moving means suited for movement from the current position to the destination. In this case, the moving means determining circuit 528 determines moving means with priorities giving to a moving time, a cost required for the movement and others. In a case where the client has a sufficient time to spare, moving means of an electric train requiring a low expense is determined, while when the client has no sufficient time to spare and wishes to reach the destination at an earlier time point, moving means of a car is determined. The moving means determining circuit 528 outputs all of the moving routes from the current position to the destination to the traffic condition data base 55, when the circuit determines moving means of a car.

The travel time detecting circuit 529 extracts routes from the current position to the destination on the basis of the current position inputted from the demultiplexer 525, the destination included in a schedule as an object for management from the data base 52, and the map data from the map data base 54. The travel time detecting circuit 529 calculates a moving speed of the car on each of the routes on the basis of traffic conditions on the moving routes up to the destination outputted from the traffic condition data base 55. The travel time detecting circuit 529 further detects travel times across the respective routes from the current position to the destination on the basis of moving speeds on the respective routes to output the minimum travel time among the detected travel times to the residual time detecting circuit 527.

The comparison circuit 530 compares the residual time or the difference in time from the residual time detecting circuit 527 with a time to spare up to a next scheduled time and outputs a signal to urge movement toward the destination to the origination circuit 523 when the residual time or the difference in time becomes equal to or less than a prescribed time to spare.

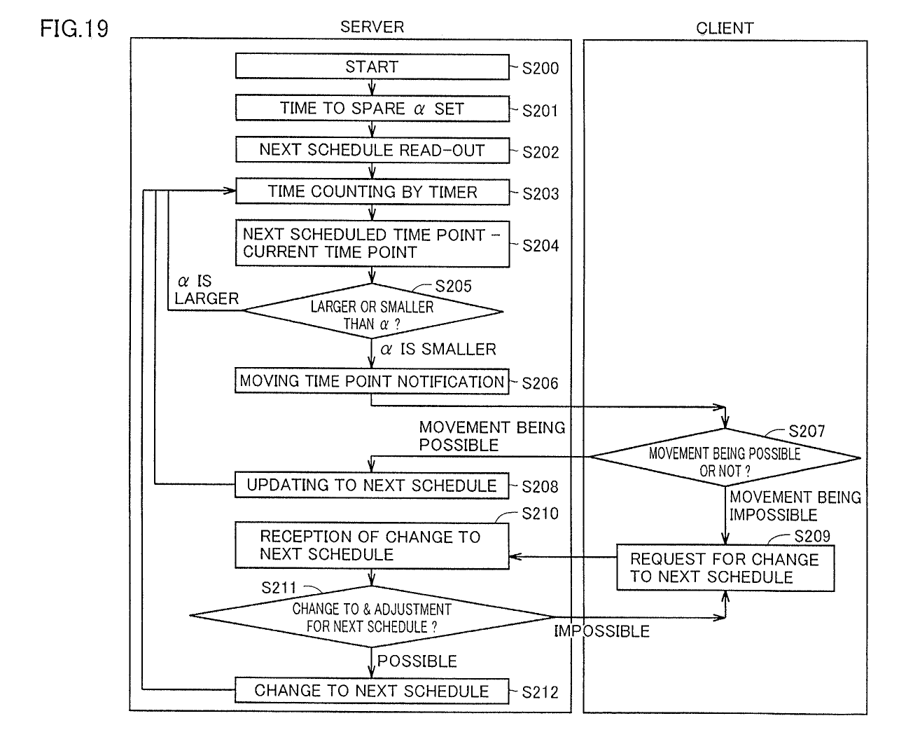

Referring to FIG. 19, description will be given of a flow chart of a schedule management method in the schedule management system 400. When a management of a schedule gets started according to a request from a client (step S200), a time to spare α till a next scheduled time point is set in the comparison circuit 530 (step S201). The data base read/write control circuit 512 controls the data base 52 such that a schedule as an object for management specified by an address of the client who has transmitted a request for management inputted from the decryption circuit 511 is outputted. The data base 52 outputs the schedule as an object for management to the residual time detecting circuit 527 (step S202). The timer 526 outputs a current time point to the residual time detecting circuit 527 (step S203), the residual time detecting circuit 527 extracts a next scheduled time point from the schedule as an object for management to detect a residual time from the current time point to the next scheduled time point and output the detected residual time to the comparison circuit 530 (step S204).

The comparison circuit 530 compares the inputted residual time with the time to spare α (step S205). If the time to spare α is larger, the steps S203 to S205 are repeated. If the time to spare α is smaller in step S205, the comparison circuit 530 outputs a moving time point at which the client should start movement to the origination circuit 523 and the origination circuit 523 originates the moving time point to the portable telephone 1 to 13 of the client (step S206). The portable telephone 1 to 13 of the client receives the moving time point with the reception circuit 61 and the decryption circuit 62 outputs the moving time point to the processing device 64. The processing device 64 displays the moving time point on the display device 65. The client judges whether or not movement is possible seeing the moving time point displayed on the display device 65 (step S207). The client inputs movement being possible to the portable telephone 1 to 13 from the input circuit 63 if movement is possible and the processing device 64 transmits the movement being possible from the input circuit 63 to the server 50B through the encryption circuit 66 and the origination circuit 67. After the transmission, the terminal device 51 updates to a next schedule to repeat the steps S203 to S208.

When movement is impossible in step S207, the client transmits a request for schedule change to the server 50B with the portable telephone 1 to 13 of the client (step S209). The server 50B receives the request for schedule change (step S210) and judges whether or not a change in the schedule is possible (step S211). If possible, the schedule is changed according to the method described in the first embodiment (step S212). Then, the steps S203 to S212 are performed. When adjustment by the change in the schedule is judged to be impossible in step S211, the process returns to step S209.

In such a way, the server 50B urges the client who has issued the request for schedule management to start movement at a time point close to the next scheduled time point.

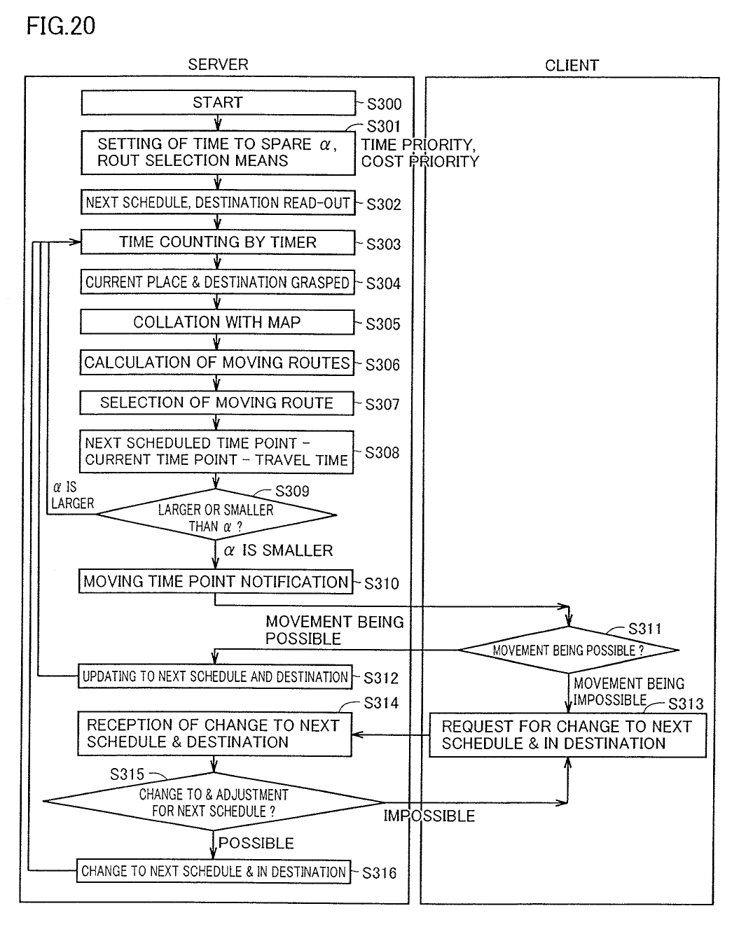

Referring to FIG. 20, description will be given to another flow chart of a schedule management method. When management of a schedule gets started according to a request from the client (step S300), a time to spare α till the next time point is set in the comparison circuit 530 and selection means for a moving route is set in a moving means determining circuit 528 (step S301). The residual time detecting circuit 527 extracts the next scheduled time point and a destination on the basis of the schedule as an object for management from the data base 52 (step S302). The timer 526 outputs a current time point to the residual time detecting circuit 527 (step S303). The moving means determining circuit 528 grasps the destination on the basis of the schedule as an object for management from the data base 52 and further grasps a current place on the basis of a current position from the demultiplexer 525 (step S304). The moving means determining circuit 528 performs collation between the map from the map data base 54 and each of the current place and the destination (step S305) to calculate moving routes from the current place to the destination (step S306). The moving means determining circuit 528 selects a moving route suited for movement from the current place to the destination among the calculated moving routes (step S307).

Thereafter, the travel time detecting circuit 529 detects a travel time from the current place to the destination according to the above described method to output the minimum travel time to the residual time detecting circuit 527. Then the residual time detecting circuit 527 calculates [the next scheduled time point−the current time point−the travel time] to output a result of the calculation to the comparison circuit 530 (step S308).

The comparison circuit 530 compares an inputted residual time =the next scheduled time point−the current time point−the travel time with the time to spare α (step S309). If the time to spare α is larger, the steps S303 to S308 are repeated. If the time to spare α is smaller in the step S309, the comparison circuit 530 outputs a moving time point at which the client should get started to the origination circuit 523 and the origination circuit 523 outputs the moving time point to the portable telephone 1 to 13 of the client (step S310). The portable telephone 1 to 13 of the client receives the moving time point through the reception circuit 61 and the decryption circuit 62 outputs the moving time point to the processing device 64. The processing device 64 displays the moving time point on the display device 65. The client judges whether or not movement is possible seeing the moving time point displayed on the display device 65 (step S311). If the movement is possible, the client inputs movement being possible to the portable telephone 1 to 13 from the input circuit 63 and the processing device 64 transmits the moving being possible from the input circuit 63 to the server 50B through the encryption circuit 66 and the origination circuit 67. The terminal device 51B performs updating to a next place and a next destination (step S312), and the steps S303 to S312 are repeated.

When movement is impossible in step S311, the client transmits a request for schedule change and destination change to the server 50B by means of the portable telephone 1 to 13 (step S313). The server 50B receives the request for schedule change and destination change (step S314) and judges whether or not the change in schedule is possible (step S315). If possible, the schedule and the destination are changed according to the method described in the first embodiment (step S316). Then, the steps S303 to S316 are performed. If it is judged that the change in schedule for adjustment is impossible in step S315, the process returns to step S313.

In such a way, the server 50B urges the client who has issued a request for schedule management to start movement at a time point close to the next scheduled time point.

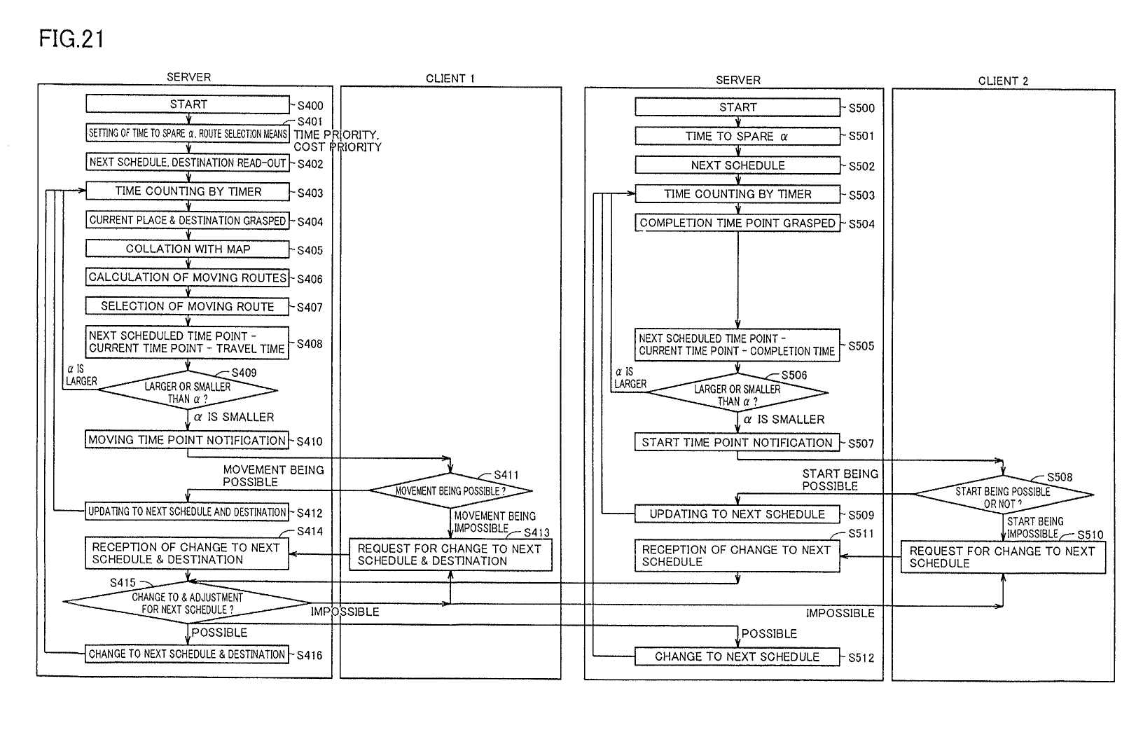

Referring to FIG. 21, description will be given of still another flow chart of a schedule management system. A flow chart shown in FIG. 21 shows a case where management is performed of a schedule of a client 1 who is a guest taking a meal at a restaurant and a schedule of a client 2 who is a restaurant cooking a meal to serve it to the guest. That is, FIG. 21 shows a flow chart in which management is performed of two schedules of the clients 1 and 2 having the same schedule as each other.

The steps S400 to S416 in which the server 50B manages the schedule of the client 1 who is a guest are the same as the steps S300 to S316 shown in FIG. 20.

On the other hand, when the server 50B starts an operation for managing the schedule of the client 2 who is a restaurant (step S500), the time to spare α is set in the comparison circuit 530 (step S501) and a next scheduled time point by which a food is completed is extracted from the schedule as an object for management in the residual time detecting circuit 527 (step S502). Then, the timer 526 outputs time information to the residual time detecting circuit 527 (step S503). The residual time detecting circuit 527 grasps a time of completion of a reserved food, on the basis of reservation contents of the food, included in the schedule as an object for management read out from the data base 52 (step S504). Then, the residual time detecting circuit 527 calculates [the next scheduled time point−the current time point−time of completion] to output a result of calculation to the comparison circuit 530 (step S505).

The comparison circuit 530 compares an inputted residual time=the next scheduled time point−the current time point−time of completion with the time of α (step of S506). If the time of spare α is larger, the steps S503 to S505 are repeated. If the time of spare α is smaller in step S506, the comparison circuit 530 outputs a start time point at which the client 2 should start cooking the food to the origination circuit 523 and the origination circuit 523 originates the start time point to the portable telephone 1 to 13 of the client 2 (step S507). The portable telephone 1 to 13 of the client 2 receives the start time point through the reception circuit 61 and the decryption circuit 62 outputs the start time point to the processing device 64. The processing device 64 displays the start time point on the display device 65. The client 2 judges whether or not the food can be started for cooking seeing the start time point displayed on the display device 65 (step S508). If the start is possible, the client 2 inputs the start being possible to the portable telephone 1 to 13 of the client 2 through the input circuit 63 and the processing device 64 transmits the start being possible from the input circuit 63 to the server 50B through the encryption circuit 66 and the origination circuit 67. Then, the terminal device 51B performs updating to the next schedule (step S509) and the steps S503 to s508 are repeated.

When the client 2 judges that the food cannot be stated for cooking in step S508, the client 2 transmits a request for schedule change to the server 50B by means of the telephone 1 to 13 (step S510). The server 50B receives the request for schedule change (step S511) and thereafter, the process goes to step S415 in which it is judged whether or not a change in schedule of the client 1 can be possible. Then, if the change in schedule of the client 1 is impossible in step S415, the process goes to step S510 and the request for schedule change on the side of the client 2 is performed. If the change in schedule of the client 1 is possible in step S415, the server 50B changes the schedules of the clients 1 and 2, and the processes moves to the respective steps S403 and S503.

In such a way, management of the schedules of guests and a restaurant can be realized such that adjustment is performed between a time point at which guests arrive at a restaurant and a time point at which a food is completed at the restaurant and thereby, when the guests actually arrive at the restaurant, the guests can be immediately served with the food. As a result, a waiting time till the food is served from when the guests arrive at the restaurant can be reduced, thereby enabling effective use of time.

In this case, considered as factors that a client 1, who is the guests, force a schedule to be changed are a delay of a arrival time due to a rapid change in a traffic condition interposing between a current position and the restaurant which is the destination, a change in reservation contents of the food on the way to the restaurant and so on. The schedules of the clients 1 and 2 can be managed by the server 50B such that the food can be served to the guests in time for arrival of the guests at the restaurant even when a change in schedule occurs due to such factors.

According to the second embodiment, the server urges each client to move toward the destination according to the schedule of the client having been registered when a current time approaches the next scheduled time point; therefore, the schedule of the client can be correctly performed.

Third Embodiment

While in the production of semiconductor devices, a production line is constructed under a great amount of investment, production of semiconductor devices is hard to ensure a production amount to a necessary level at all times in an individual company. Not only is the production amount easy to be affected by a poor business condition but also the production line is required to have been depreciated in earlier years after construction. Therefore, construction of the production line is an investment accompanying a risk.

In the third embodiment, description will be given of schedule adjustment covering plural production lines for ensuring a stable production amount of semiconductor devices with less investment risk.

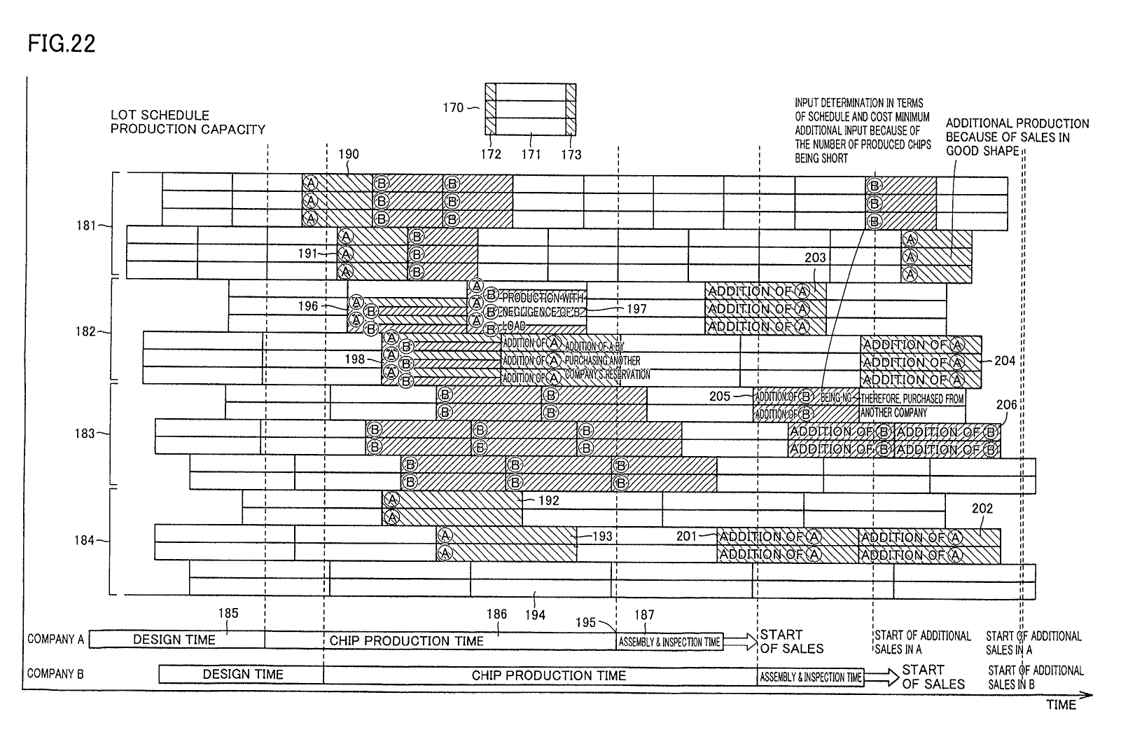

Referring to FIG. 22, production lines as an object for schedule adjustment are production lines 181 to 184. The production line 181 is used for production of semiconductor integrated circuit chips with relatively mild design rules and a small number of interconnection layers, with a lead time as short as 2 months and with a high yield and a low production cost per wafer. The production line 182 is used for production of semiconductor integrated circuit chips with relatively small design rules and many interconnection layers, therefore with a lead time relatively as long as 3.5 months and with a lower production yield compared with the production line 181 and a relatively high production cost per wafer. The production line 183 is used for production of semiconductor integrated circuit chips with relatively small design rules and a small number of interconnection layers, with a lead time relatively as short as 3 months compared with the production line 182 and with a higher production yield compared with the production line 182 and a relatively high production cost per wafer. The production line 184 is used for production of semiconductor integrated circuit chips with small design rules and many interconnection layers, therefore with a lead time as long as 4 months and with a low production yield and a high production cost per wafer. In the production line 184, however, since a chip area is the least, the number of chips per wafer is the most; therefore, if a high production yield can be ensured, the lowest chip production cost can be realized. Accordingly, if lots are processed in a period with a high production yield, a production volume in chips can be achieved with a smaller number of lots than a scheduled number of lots; therefore, a residual lot capacity can be sold to another company, thereby, enabling a profit on sale of the residual lot capacity to be attained.

In the semiconductor production line including 4 production lines 181 to 184, the number of lots that can be processed in each of the lines and regular schedules thereof are recorded and an actual number of lots required is ensured so as to meet the regular schedules and business schedules of user companies. Herein, each lot in a lot schedule is set with a flexibility time zone. That is a lot schedule 170 is composed of a lot 171 which is an essential semiconductor production time and flexibility time zones 172 and 173. Herein, as the flexibility time zones 172 and 173, there can be named: an error of a production time in a production line due to a delay in production caused by an unpredictable accident, a trouble and 5 others or due to a time reduction due to expected acceleration in production and others. When a user company A requests production of semiconductor devices characterized by a design time 185, a chip production time 186, and an assembly and inspection time 187 in the above described production lines 181 to 184, allocation of lots are performed so as to conform with 110 production periods of the respective production lines 181 to 184 after the design time 185 ends.

To ensure the number of lots to meet a necessary number of chips in a production period of time is attained by allocating lots through a cost minimum simulation in a given period of time.

A total cost Ctotal is determined by the following equation:

Ctotal=Cα+Nα+Mα+Cβ+Nβ+Mβ+ . . . (1)

, wherein Cα is a production cost per wafer in the production line 181, Nα is the number of wafers per lot in the production line 181, Mα is the number of lots in the production line 181; Cβ is a production cost per wafer in the production line 182, Nβ is the number of wafers per lot in the production line 182 and Mβ is the number of lots in the production line 182.

Furthermore, the total number of chips Xtotal is determined by the following equation:

Xtotal=Xα+Xβ+ . . . =(Aw/Acα)×Yα×Nα×Mα+(Aw/Acβ)×Yβ×Nβ×Mβ+ . . . (2)

, wherein Aw is a wafer area, Acα is a chip area in the production line 181, Yα is a product yield in the production line 181 and Xα is the number of produced chips in the production line 181; and Acβ is a chip area in the production line 182, Yβ is a product yield in the production line 182 and Xβ is the number of produced chips in the production line 182.

From the equations (1) and (2), the following equation is given:

Ctotal=Xα/((Aw/Acα)×Yα)×Cα+Xβ/((Aw/Acβ)×Yβ)×Cβ+ . . . (3).

Then, a combination of Xα, Xβ, . . . is determined such that the Ctotal is minimized by changing a combination of Xα, Xβ, . . . over the production lines 181 to 184 which can be used in the production period of time. This is a cost minimum simulation.

In the case of the user company A, the lots 190 and 191 are allocated in the production line 181 as a pre-production and a production is performed according to a process with a lead time as short as 2 months. Since the production line 181 is a process having a sufficiently high, technical experience and a small number of steps, a low cost and a high product yield are realized. In the production line 181, however, since a chip area increases, the number of chips per wafer decreases. Hence, when semiconductor devices are produced in the production line 181 only, a production cost increases contrary to expectations.

Therefore, semiconductor production is performed in the production line 184 in which the number of chips per wafer is large. The lots 192 to 194 are set according to the regular schedule in the production line 184. If flexibility time zones are set to the lot 194, however, the lot 194 exceeds a time limit 195 of the chip production time 186 requested by the user company A. Therefore, the lot 194 is automatically removed at the last stage in order to avoid a risk.

A schedule is also set to a request for semiconductor production from a user company B as is similar to the above described case.

There is also a case where a company conflicts with another company in scheduling according to a production line on which allocation is performed. In such a case, there are measures to be taken: one is that lots are converted into securities to allocate the lots to a company who evaluates the lots at the highest value and the other is that an investment in the same lot is divided at a prescribed ratio.

In the case of allocation at a prescribed ratio, when it is judged that, that companies A and B jointly perform an investment at a ratio of 3 to 2, respectively, in the production line 182 having a lead time of 3.5 months is the least expensive way in terms of a lead time and a cost, lots 196 to 198 are allocated on the production line 182. In such a way, the companies A and B each secure a necessary number of chips at a low cost.

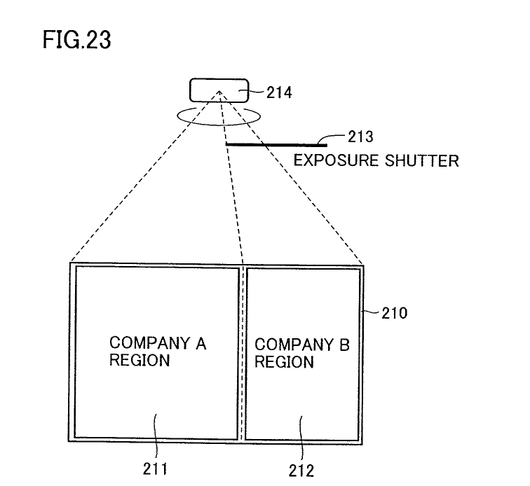

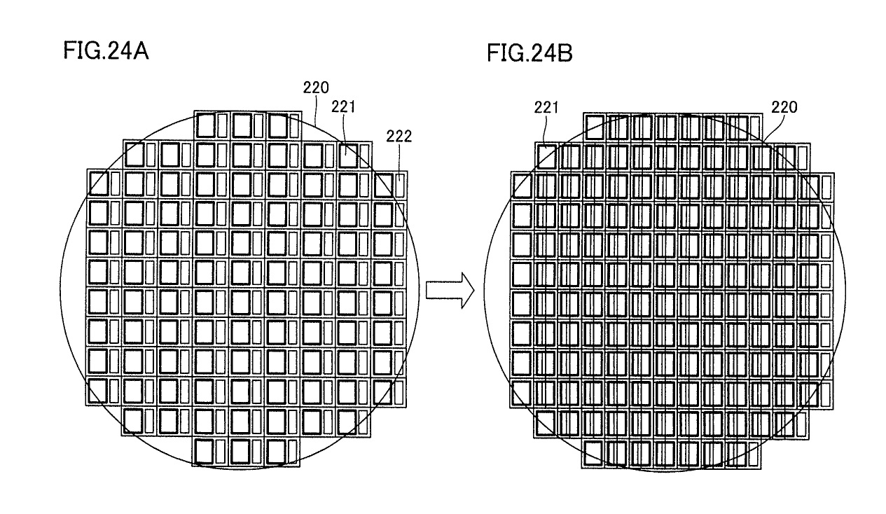

In the production line 182 in which the companies A and B are jointly participated in production, chip data of the company A and chip data of the company B are loaded on the same photomask data for production. That is, as shown in FIG. 23, the photomask 210 is composed of a region 211 for the company A and a region 212 for the company B. With this photomask adopted, when only chips for the company A are desired, the region 212 for the company B is masked by a shutter 213 and thereby, only the region 211 for the company A is used for exposure with light therethrough from an exposure device 214. In a case where chips of the company A and chips of the company B are formed on the same wafer without masking using the shutter 213, there exist on a wafer 220 as shown in FIG. 24A a chip region 221 for the company A and a chip region 222 for the company B. In contrast to this, if only chips of the company A are desired to be produced by masking with the shutter 213, exposure is performed with multiple steps each corresponding to a width of chip region 221 for the company A, such that the chip region 221 for the company A, as shown in FIG. 24B, can be formed on the wafer 220, enabling the number of chips produced to increase.

Referring again to FIG. 22, lots 201 to 204 of the company A and lots 205 and 206 of the company B are allocated to prepare for additional sales. However, if a trouble occurs and it is found that the number of chips, to be additionally produced, of the company B is short, additional lots that can meet a remaining schedule are allocated. If no unassigned time zone is available for such lots as to be newly allocated, the time zone is purchased from another company. Furthermore, to the contrary, if a product yield is better than expectation and therefore, an unassigned time zone occurs in an allocated lot, the unassigned time zone can be sold to another company.

Schedule adjustment covering semiconductor production lines as described above can be performed using the schedule adjustment system shown in FIG. 1. A schedule adjustment method adopted in that case is of the same description as in the first embodiment.

According to the third embodiment, in a case where a production time of a product is allocated in semiconductor production lines, if a flexibility time is added to the allocated production time and thereby, a total production time exceeds a production time limit, the allocation of the production time is cancelled, therefore, enabling semiconductor products to be produced with the least possible risk.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A schedule adjustment method adjusting plural schedules, in each of which a registration time zone and a first flexibility time zone showing a range in which said registration time zone can be changed are set, comprising:
a first step of extracting plural schedules each as an object for adjustment from said plural schedules in response to a request for schedule adjustment;
a second step of receiving a schedule whose adjustment is requested and which is composed of a desired time zone and a second flexibility time zone showing a range in which said desired time zone can be changed;
a third step of comparing said schedule whose adjustment is requested with said plural schedules each as an object for adjustment to adjust such that said schedule whose adjustment is requested coincides with plural schedule setting enabling time zones of said plural schedules each as an object for adjustment;
a fourth step of updating said plural schedules each as an object for adjustment when said schedule whose adjustment is requested coincides with said plural schedule setting enabling time zones; and
a fifth step of originating a result of the adjustment in said third step,
wherein said schedule setting enabling time zone is a time zone obtained by summing an unassigned time zone and said first flexibility time zone.

2. The schedule adjustment method according to claim 1, wherein in said third step, said schedule whose adjustment is requested is adjusted so as to coincide with said plural unassigned time zones by changing said desired time zone in a range of said second flexibility time zone when said desired time zone does not coincide with said plural unassigned time zones.

3. The schedule adjustment method according to claim 2, wherein in said third step, said schedule whose adjustment is requested is adjusted so as to coincide with said plural unassigned time zones by further changing said plural unassigned time zones in ranges of said respective corresponding first flexibility time zones when said schedule whose adjustment is requested does not coincide with said plural unassigned time zones even if said desired time zone is changed in a range of said second flexibility time zone.

4. The schedule adjustment method according to claim 3, wherein in said third step, a common time zone in which a schedule in common with said the plural schedules each as an object for adjustment can be set is further detected when said schedule whose adjustment is requested does not coincide with said plural unassigned time zones even if said plural unassigned time zones are changed in ranges of said respective corresponding first flexibility time zones.

5. A schedule management method managing plural schedules in each of which a registration time zone and a flexibility time zone showing a range in which said registration time zone can be changed are set, comprising:
a first step of extracting plural schedules each as an object for management having the same schedule from said plural schedules in response to a request for schedule management;
a second step of detecting a residual time till a next scheduled time point from a current time point on the basis of said plural schedules each as an object for management;
and a third step of transmitting a residual time detected in said second step to a client.

6. The schedule management method according to claim 5, further comprising a fourth step of originating a notification signal to urge a client to move to a destination at said next scheduled time point when said residual time is compared with a prescribed value and said residual time coincides with said prescribed value.

7. The schedule management method according to claim 5, wherein in said fourth step, a travel time of a client, who has transmitted said request for schedule management, from a current position to a destination included in said plural schedules each as an object for management is further detected to originate said notification signal on the basis of a difference in time obtained by subtracting said travel time from said residual time.

8. The schedule management method according to claim 6, further comprising a fifth step of changing a next scheduled time point included in said plural schedules each as an object for management in a range of said flexibility time zone in response to a request for schedule change to detect said residual time on the basis of a next scheduled time point changed.

9. A schedule management method managing plural schedules in each of which a registration time zone and a first flexibility time zone showing a range in which said registration time zone can be changed are set, comprising:
a first step of extracting plural schedules each as an object for management from said plural schedules in response to a request for schedule management;
a second step of receiving a schedule whose adjustment is requested and which is composed of a desired time zone and a second flexibility time zone showing a range in which said desired time zone can be changed;
a third step of comparing said schedule whose adjustment is requested with said plural schedules each as an object for adjustment to adjust such that said schedule whose adjustment is requested coincide with plural schedule setting enabling time zones of said plural schedules each as an object for adjustment;
a fourth step of updating said plural schedules each as an object for adjustment when said schedule whose adjustment is requested coincides with said plural schedule setting enabling time zones; and
a fifth step of originating a result of adjustment in said third step,
wherein said schedule setting enabling time zone is a time zone obtained by summing of an unassigned time zone and said first flexibility time zone, and
in said third step, when said first flexibility time zone exceeds a limited time in said adjusted plural schedules each as an object for adjustment, a schedule as an object for adjustment to which said first flexible time zone exceeding is set is removed.

10. The schedule management method according to claim 9, wherein said plural schedules are schedules for use in managing a production process of a production line.

11. The schedule management method according to claim 9, wherein said plural schedules are schedules for use in managing production processes of production lines with respective different production capabilities.

12. A schedule management apparatus comprising:
a schedule storage circuit storing plural schedules in each of which a registration time zone and a first flexibility time zone showing a range in which said registration time zone can be changed are set;
a reception circuit receiving a schedule whose adjustment is requested and which is composed of a desired time zone and a second flexibility time zone showing a range in which said desired time zone can be changed;
a schedule read circuit reading plural schedules each as an object for adjustment from said schedule storage circuit in response to a request for schedule adjustment received by said reception circuit;
a schedule adjustment circuit comparing said schedule whose adjustment is requested with said plural schedules each as an object for adjustment to adjust such that said schedule whose adjustment is requested coincides with plural schedule setting enabling time zones of said plural schedules each as an object for adjustment;
a schedule updating circuit updating each of said plural schedules each as an object for adjustment on the basis of said schedule whose adjustment is requested when said schedule whose adjustment is requested coincides with said plural schedule setting enabling time zones;
a schedule rewrite circuit rewriting corresponding plural schedules stored in said schedule storage circuit with plural updated schedules updated by said schedule updating circuit; and
an origination circuit originating a result of adjustment effected by said schedule adjustment circuit,
wherein said schedule setting enabling time zone is a time zone obtained by summing an unassigned time zone and said first flexibility time zone.

13. The schedule management apparatus according to claim 12, wherein said schedule adjustment circuit adjusts such that said schedule whose adjustment is requested coincides with a plurality of said unassigned time zones by changing said desired time zone in a range of said second flexibility time zone when said desired time zone does not coincide with plural unassigned time zones.

14. The schedule management apparatus according to claim 13, wherein said schedule adjustment circuit adjusts such that said schedule whose adjustment is requested coincides with said plural unassigned time zones by further changing each of said plural unassigned time zones in a range of said corresponding first flexibility time zone when said schedule whose adjustment is requested does not coincides with said plural unassigned time zones even if said desired time zone is changed in a range of said second flexibility time zone.

15. The schedule management apparatus according to claim 14, wherein said schedule adjustment circuit outputs a common time zone in which a schedule in common with said plural schedules each as an object for adjustment can be set when said schedule whose adjustment is requested does not coincides with said plural unassigned time zones even if said plural unassigned time zones are changed in ranges of said respective corresponding first flexibility time zones and said origination circuit originates said common time zone.
